(19) United States
(12) Patent Application Publication
(10) Pub. No.: US 2017/0314752 A1
(43) Pub. Date: Nov. 2, 2017

(54) DAYLIGHTING DEVICE AND DAYLIGHTING SYSTEM

(71) Applicant: SHARP KABUSHIKI KAISHA, Sakai City, Osaka (JP)

(72) Inventors: Hideomi YUI, Sakai City, Osaka (JP); Tsuyoshi KAMADA, Sakai City, Osaka (JP); Shun UEKI, Sakai City, Osaka (JP); Tomoko UEKI, Sakai City, Osaka (JP); Shumpei NISHINAKA, Sakai City, Osaka (JP); Toru KANNO, Sakai City, Osaka (JP); Daisuke SHINOZAKI, Sakai City, Osaka (JP)

(21) Appl. No.: 15/522,002

(22) PCT Filed: Oct. 21, 2015
(86) PCT No.: PCT/JP2015/079715

§ 371 Date: Apr. 26, 2017

(30) Foreign Application Priority Data
Oct. 28, 2014 (JP) 2014-219604

(51) Int. Cl. F21S 11/00; F21V 11/04; F21V 7/00; F21S 13/02; E06B 9/42; E06B 9/28; H05B 37/02; E06B 9/24

(52) U.S. Cl. CPC F21S 11/007; H05B 37/0218; F21V 11/04; F21V 7/0091; E06B 9/24; F21S 13/02; E06B 9/42; E06B 9/28; E06B 2009/2417

(57) ABSTRACT

A daylighting device according to one aspect of the present invention includes a daylighting member including a first substrate having light transparency and a plurality of daylighting units having light transparency which are provided on a first surface of the first substrate, in which the daylighting unit has a reflective surface which reflects light incident to the daylighting unit, the light which is reflected on the reflective surface and emitted from a second surface of the first substrate has characteristics that the light proceeds toward a space on the same side as the side where the light is incident to the reflective surface among two spaces divided with a virtual plane as a boundary which is vertical to the second surface of the first substrate and parallel to an extension direction of the daylighting unit, and the daylighting member exhibits light absorption characteristics for absorbing a part of the light incident to the plurality of daylighting units.

### TECHNICAL FIELD

The present invention relates to a daylighting device and a daylighting system.

This application claims priority based on Japanese Patent Application No. 2014-219604, filed on Oct. 28, 2014, the content of which is incorporated herein by reference.

### BACKGROUND ART

As a technique for effectively guiding light incident to a window glass to indoors, for example, a technique described in PTL 1 is known. The technique of PTL 1 is used to guide light by attaching a daylighting film, which has a plurality of unit prisms formed on one surface of a transparent support of the daylighting film to perform a daylighting function, on an inner surface (indoor side surface) of a window glass. The light incident from the unit prism side of the daylighting film is refracted at surfaces of the unit prisms, passes through the unit prisms, the support, and the window glass and enters the indoor space.

### CITATION LIST

### Patent Literature

PTL 1: Japanese Unexamined Patent Application Publication No. 2011-123478

### SUMMARY OF INVENTION

### Technical Problem

In some cases, however, depending on the variation in latitude and orientation of a location where a window is disposed or sun altitude, daylighting effect to illuminate a ceiling is decreased or diffused light enters eyes of a person in indoors so as to cause the person to feel uncomfortable dazzle. In the following description, the light that makes the person in indoors feel dazzle is referred to as glare.

One aspect of the present invention has been made in consideration of the aforementioned problems of the related art, and an object of the present invention is to provide a daylighting device and a daylighting system capable of securing a favorable indoor environment not causing a person in indoors to feel dazzle by further suppressing glare.

### Solution to Problem

A daylighting device according to one aspect of the present invention includes a daylighting member including a first substrate having light transparency and a plurality of daylighting units having light transparency which are provided on a first surface of the first substrate, in which the daylighting unit has a reflective surface which reflects light incident to the daylighting unit, and the light which is reflected on the reflective surface and emitted from a second surface of the first substrate has characteristics that the light travels toward a space on the same side as the side where the light is incident to the reflective surface among two spaces divided with a virtual plane as a boundary which is vertical to the second surface of the first substrate and parallel to an extension direction of the daylighting unit, and in which the daylighting member exhibits light absorption characteristics for absorbing a part of the light incident to the plurality of daylighting units.

The daylighting device according to one aspect of the present invention may have a configuration that at least one of the plurality of daylighting units and the first substrate exhibits the light absorption characteristics.

The daylighting device according to one aspect of the present invention may have a configuration that at least one of the daylighting units and the first substrate is configured of a material having the light absorption characteristics.

The daylighting device according to one aspect of the present invention may have a configuration that one or more light absorption layers are provided on the first substrate.

The daylighting device according to one aspect of the present invention may have a configuration that the light absorption layer is provided over the entire region in the first surface of the first substrate.

The daylighting device according to one aspect of the present invention may have a configuration that the plurality of light absorption layers are provided and the plurality of light absorption layers are provided with an interval therebetween in an arrangement direction of the plurality of daylighting units.

The daylighting device according to one aspect of the present invention may have a configuration that the plurality of light absorption layers are provided and the plurality of light absorption layers are provided with an interval therebetween in a plate thickness direction of the first substrate.

The daylighting device according to one aspect of the present invention may have a configuration that a light transmittance of the light absorption layer is less than 90%.

The daylighting device according to one aspect of the present invention may have a configuration that the light absorption layer is detachably provided on the first substrate.

The daylighting device according to one aspect of the present invention may have a configuration that the daylighting member is attached to an installation target through an adhesive layer which is provided on any one side of the plurality of daylighting units and the second surface of the first substrate.

The daylighting device according to one aspect of the present invention may have a configuration that the adhesive layer has light absorption characteristics.

The daylighting device according to one aspect of the present invention may have a configuration that a daylighting panel including the daylighting member and a frame that supports the daylighting member and a mounting portion for detachably mounting the daylighting panel are provided to the installation target.

A daylighting apparatus according to one aspect of the present invention includes a plurality of slats which are disposed side by side with a prescribed interval therebetween, and a tilting mechanism that supports the slats so as to be freely tilted, in which the daylighting device is used for at least a part of the plurality of slats.

A daylighting apparatus according to one aspect of the present invention includes a daylighting screen and a winding mechanism that causes the daylighting screen to be freely wound and the daylighting device is used as the daylighting screen.

A daylighting apparatus according to one aspect of the present invention includes, at least, a first glass substrate which has light transparency and to which external light is incident, a second glass substrate which is disposed facing the first glass substrate and has light transparency, and the daylighting device which is disposed between the first glass substrate and the second glass substrate, or on the second glass substrate.

A daylighting system according to one aspect of the present invention includes a daylighting device, an indoor lighting device, a detection unit that detects indoor illuminance, and a control unit that controls the indoor lighting device and the detection unit, in which the daylighting device is adopted as the daylighting device.

The daylighting system according to one aspect of the present invention may have a configuration that the daylighting device is provided on a low emissivity glass.

### Advantageous Effects of Invention

One aspect of the present invention has been made in consideration of the aforementioned problems of the related art, and an object of the present invention is to provide a daylighting device and a daylighting system capable of securing a favorable indoor environment not causing a person in indoors to feel dazzle by further suppressing glare.

### BRIEF DESCRIPTION OF DRAWINGS

FIG. 1 is a cross-sectional view for illustrating a schematic configuration of a daylighting device according to a first embodiment of the present invention.

FIG. 2 is an enlarged cross-sectional view for illustrating a main part of the daylighting device according to first embodiment.

FIG. 3 is a schematic diagram for illustrating an example of a room model.

FIG. 4 is a diagram for illustrating definitions of an incident angle θ_{IN} of incident light L_{IN} incident to the daylighting device and an emission angle θ_{OUT} of emission light L_{OUT} emitted from the daylighting device.

FIG. 5 is a diagram for illustrating characteristics of a conventional daylighting device.

FIG. 6A is a first diagram for illustrating characteristics of the daylighting device according to the first embodiment.

FIG. 6B is a second diagram for illustrating characteristics of the daylighting device according to the first embodiment.

FIG. 7 is a graph for illustrating characteristics of the daylighting device according to the first embodiment.

FIG. 8A is a first cross-sectional view for illustrating a modification example of the daylighting device according to the first embodiment.

FIG. 8B is a second cross-sectional view for illustrating the modification example of the daylighting device according to the first embodiment.

FIG. 8C is a third cross-sectional view for illustrating the modification example of the daylighting device according to the first embodiment.

FIG. 8D is a fourth cross-sectional view for illustrating the modification example of the daylighting device according to the first embodiment.

FIG. 8E is a fifth cross-sectional view for illustrating the modification example of the daylighting device according to the first embodiment.

FIG. 8F is a sixth cross-sectional view for illustrating the modification example of the daylighting device according to the first embodiment.

FIG. 8G is a seventh cross-sectional view for illustrating the modification example of the daylighting device according to the first embodiment.

FIG. 9 is a cross-sectional view for illustrating a schematic configuration of a daylighting device according to a second embodiment.

FIG. 10 is an enlarged cross-sectional view for illustrating a main part of the daylighting device according to the embodiment.

FIG. 11 is a perspective view for illustrating an arrangement example of a plurality of light shielding layers in the daylighting device.

FIG. 12 is a perspective view for illustrating the other example of the arrangement of the plurality of light shielding layers.

FIG. 13 is a diagram for illustrating characteristics of the daylighting device according to the second embodiment.

FIG. 14A is a cross-sectional view for illustrating a modification example of a daylighting film according to the second embodiment.

FIG. 14B is a diagram for illustrating characteristics of the daylighting film illustrated in FIG. 14A.

FIG. 15A is a first cross-sectional view for illustrating another modification example of the daylighting film according to the second embodiment.

FIG. 15B is a second cross-sectional view for illustrating sill another modification example of the daylighting film according to the second embodiment.

FIG. 15C is a third cross-sectional view for illustrating still another modification example of the daylighting film according to the second embodiment.

FIG. 16A is a first perspective view for illustrating still another modification example of the daylighting film according to the second embodiment.

FIG. 16B is a second perspective view for illustrating still another modification example of the daylighting film according to the second embodiment.

FIG. 17A is a cross-sectional view for illustrating a schematic configuration of a daylighting device having light absorption characteristics according to a third embodiment.

FIG. 17B is a plan view for illustrating a schematic configuration of a light absorption film.

FIG. 18A is a cross-sectional view for illustrating a schematic configuration of the daylighting device having light shielding characteristics according to the third embodiment.

FIG. 18B is a plan view for illustrating a schematic configuration of a light shielding film.

FIG. 19A is a graph for illustrating sun seasonal variations and is a graph for illustrating changes in sun altitude and sun orientation in spring equinox.

FIG. 19B is a graph for illustrating sun seasonal variations and is a graph for illustrating changes in sun altitude and sun orientation in summer equinox.

FIG. 19C is a graph for illustrating sun seasonal variations and is a graph for illustrating changes in sun altitude and sun orientation in autumn equinox.

FIG. 19D is a graph for illustrating sun seasonal variations and is a graph for illustrating changes in sun altitude and sun orientation in winter equinox.

FIG. 20 is a diagram for illustrating a usage example of the daylighting device (a light absorption film or a light shielding film).

FIG. 21 is a diagram for illustrating the usage example of the daylighting device (the light absorption film or the light shielding film).

FIG. 22A is a first cross-sectional view for illustrating a configuration example of a daylighting device according to a fourth embodiment.

FIG. 22B is a second cross-sectional view for illustrating a configuration example of the daylighting device according to the fourth embodiment.

FIG. 22C is a third cross-sectional view for illustrating a configuration example of the daylighting device according to the fourth embodiment.

FIG. 23A is a first cross-sectional view for illustrating a configuration example of a daylighting device according to a fifth embodiment.

FIG. 23B is a second cross-sectional view for illustrating a configuration example of the daylighting device according to the fifth embodiment.

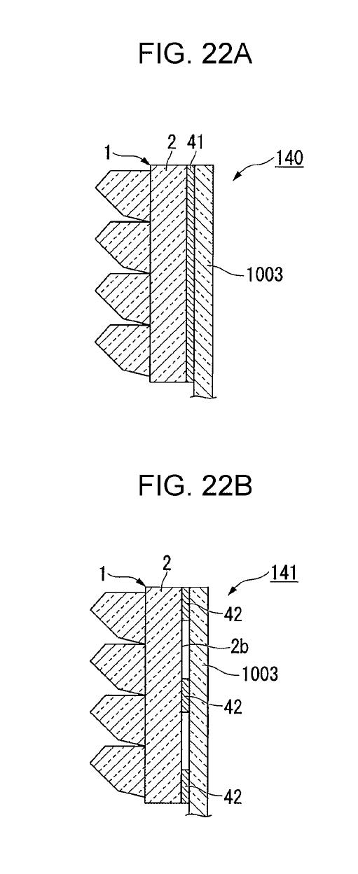

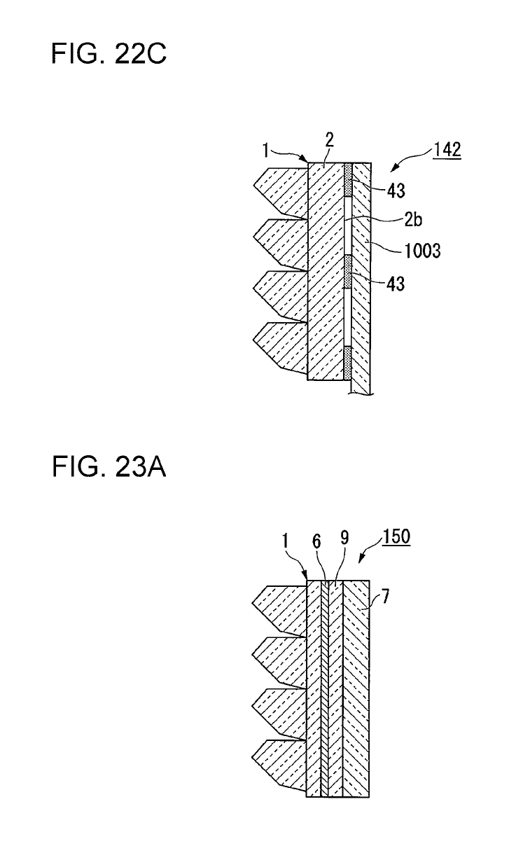

FIG. 22C is a third cross-sectional view for illustrating a configuration example of the daylighting device according to the fifth embodiment.

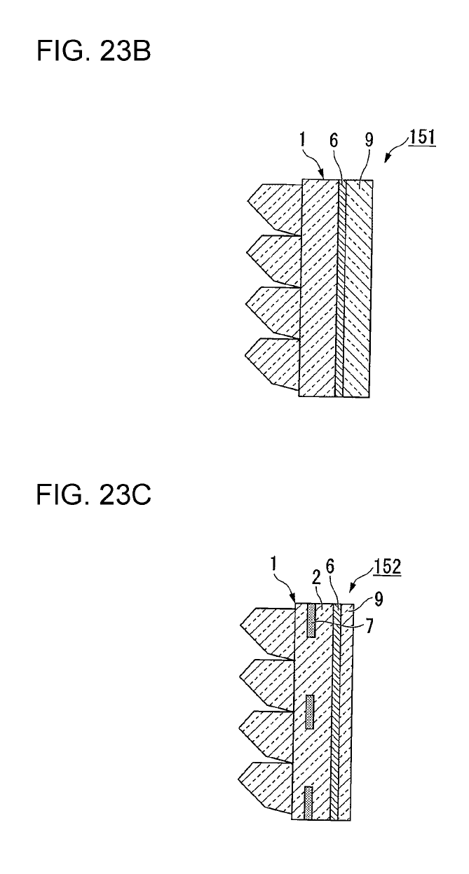

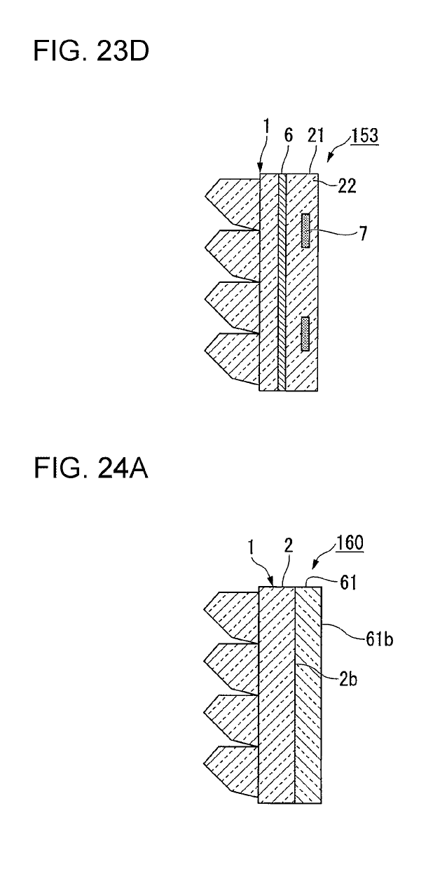

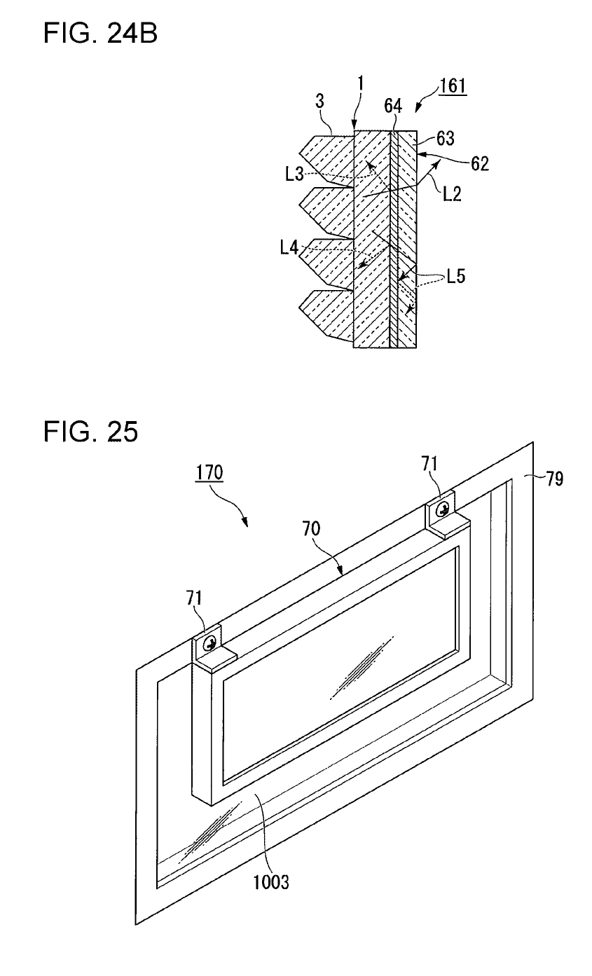

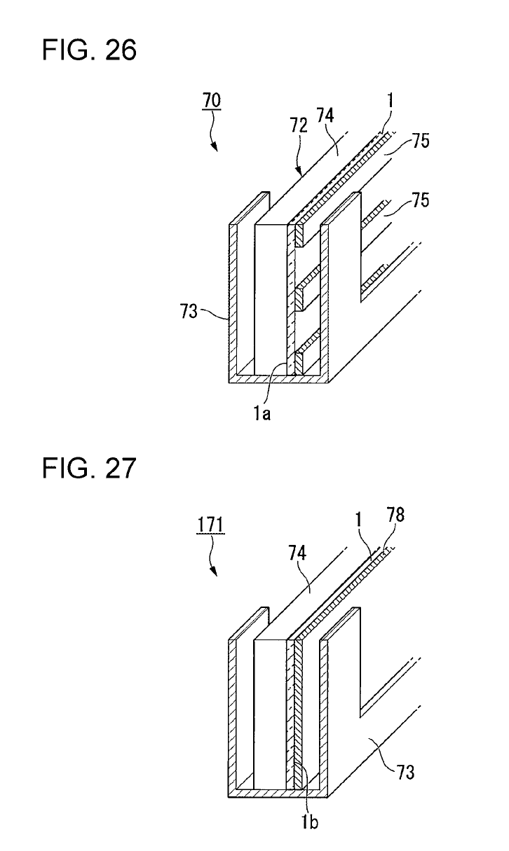

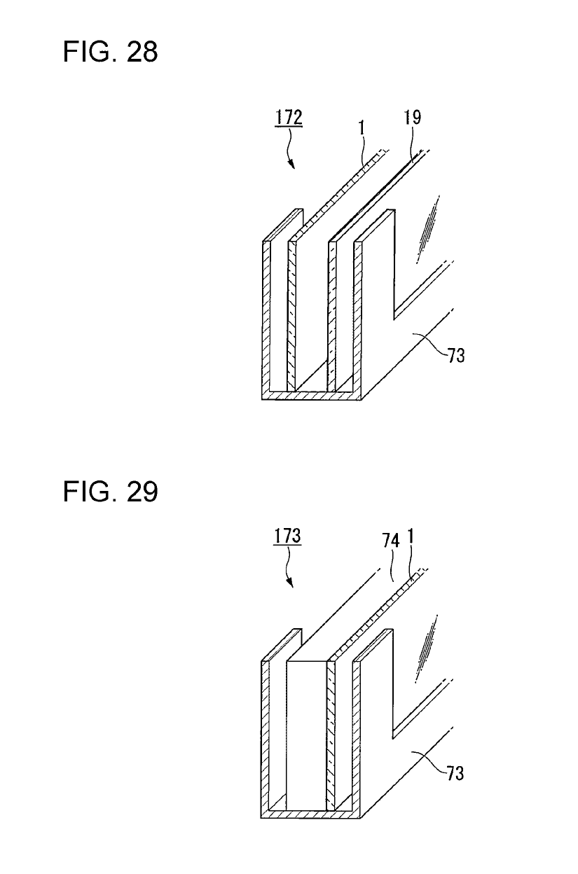

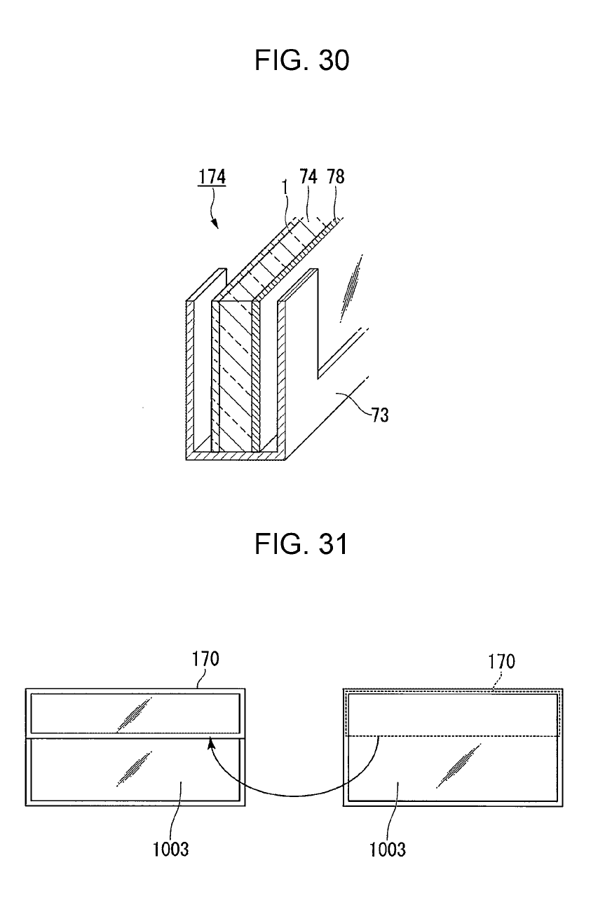

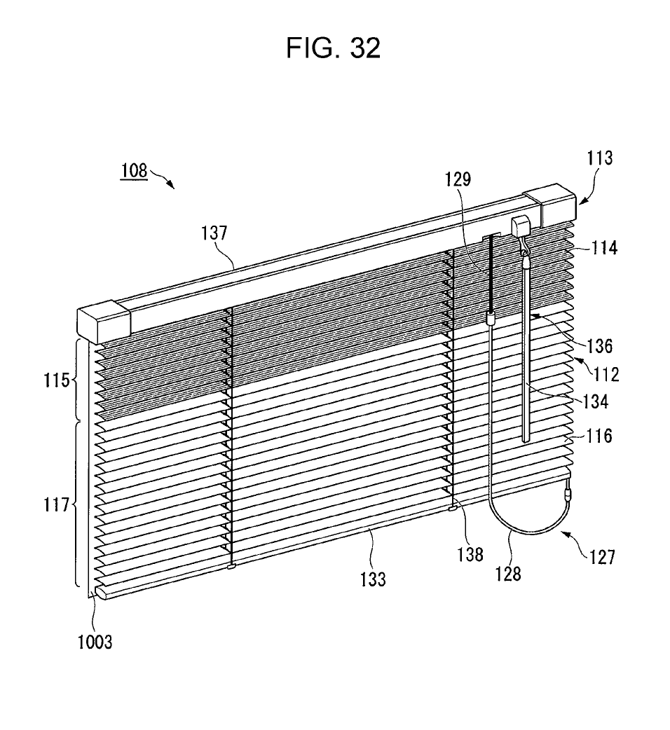

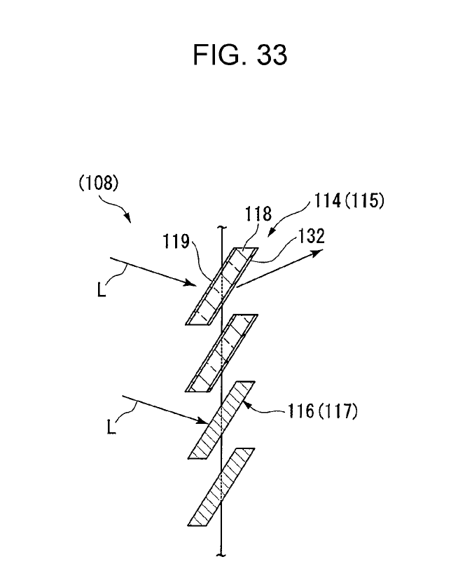

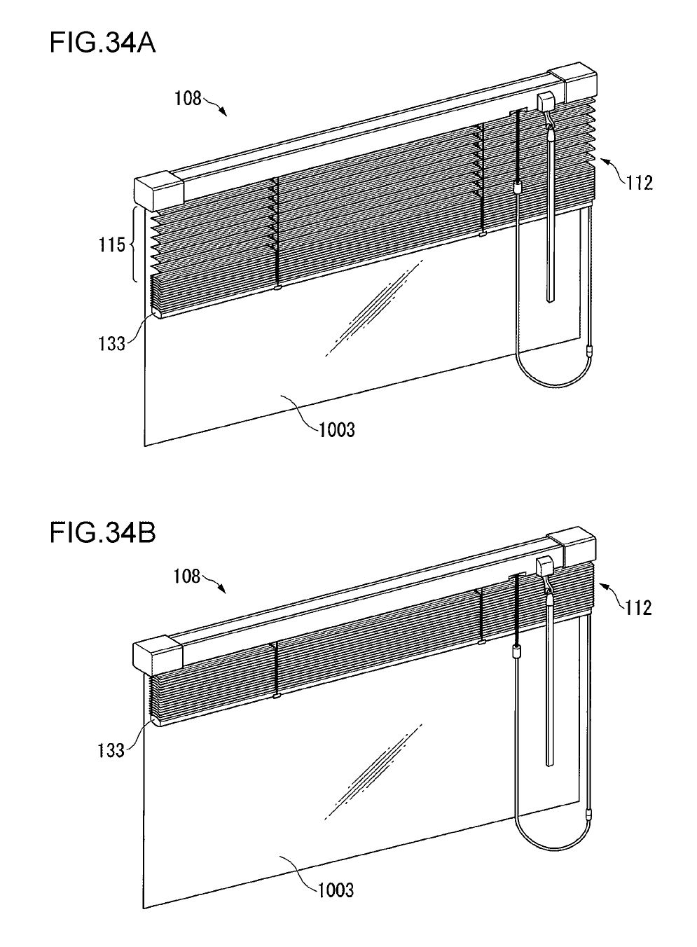

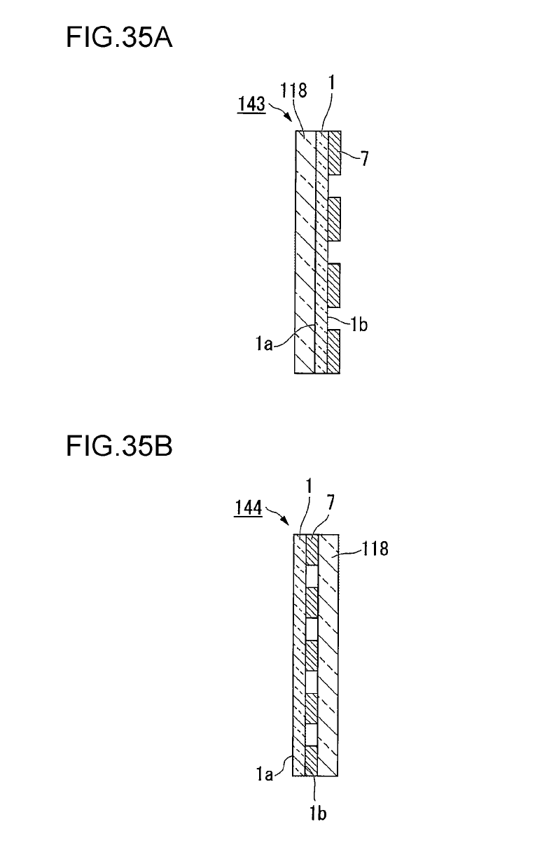

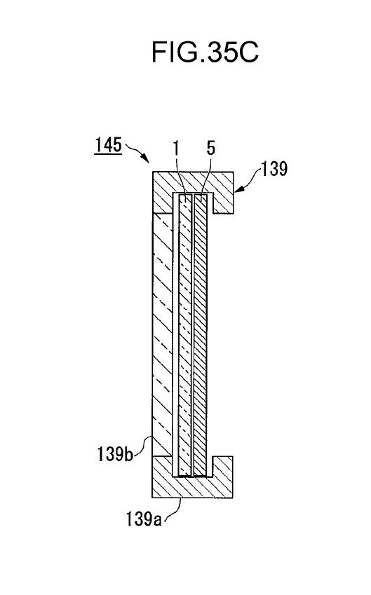

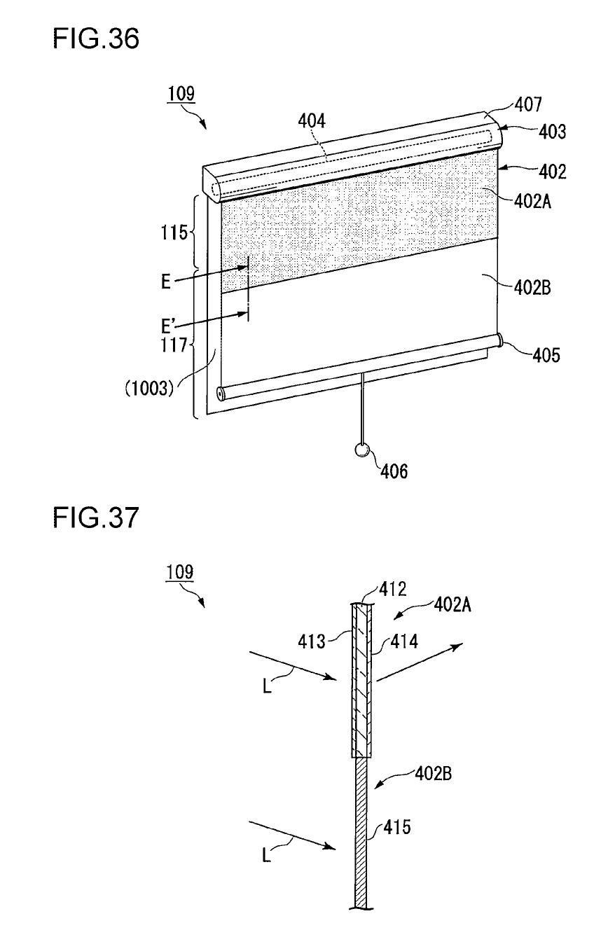

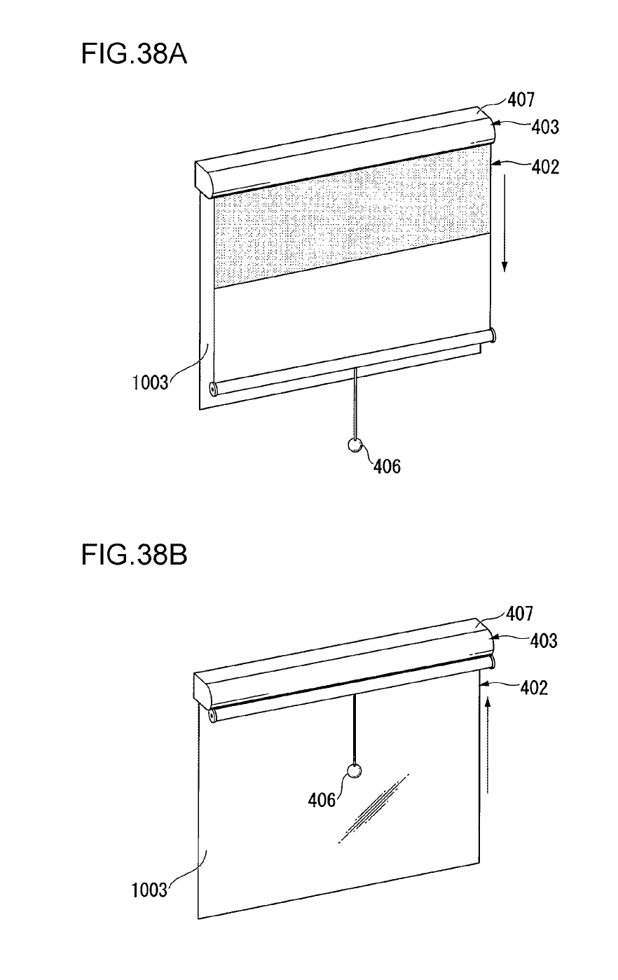

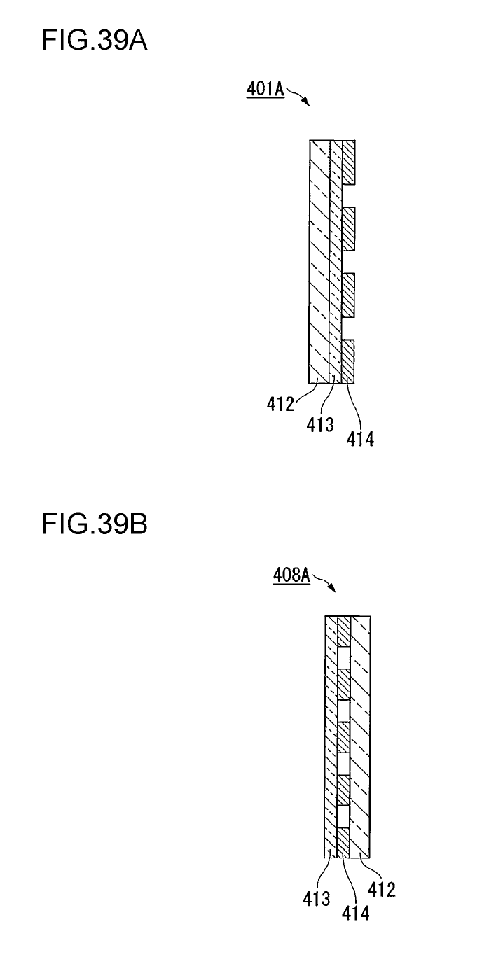

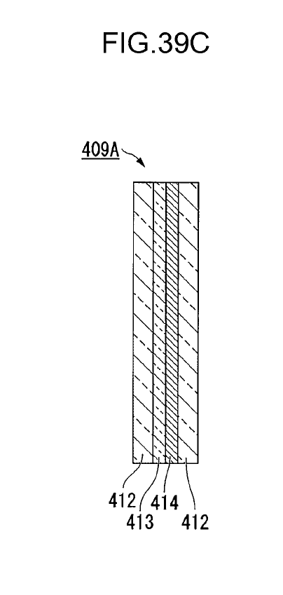

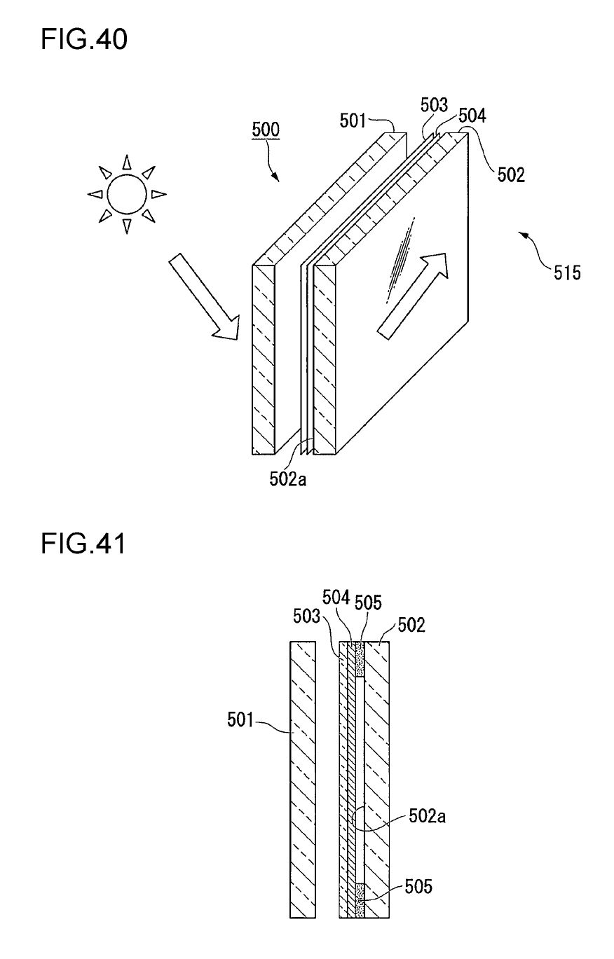

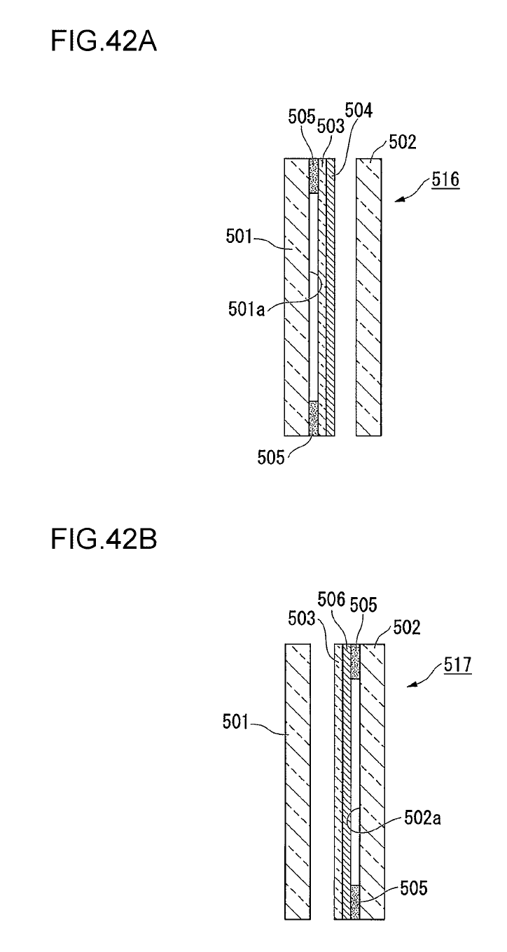

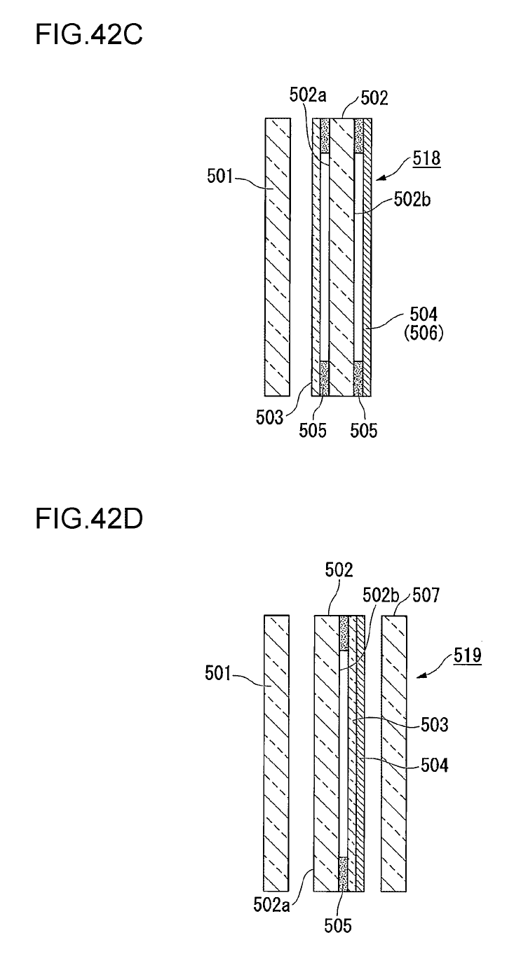

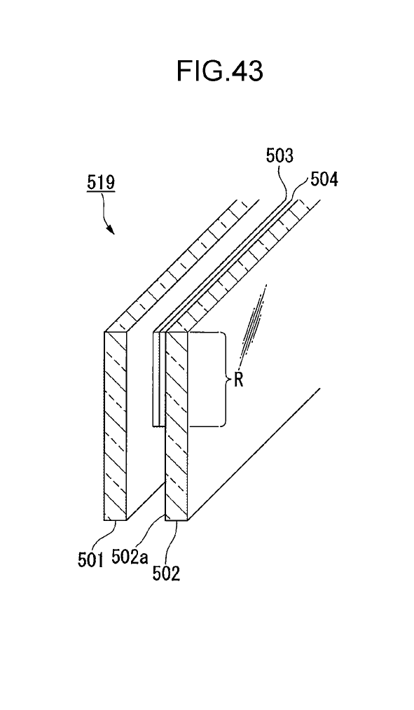

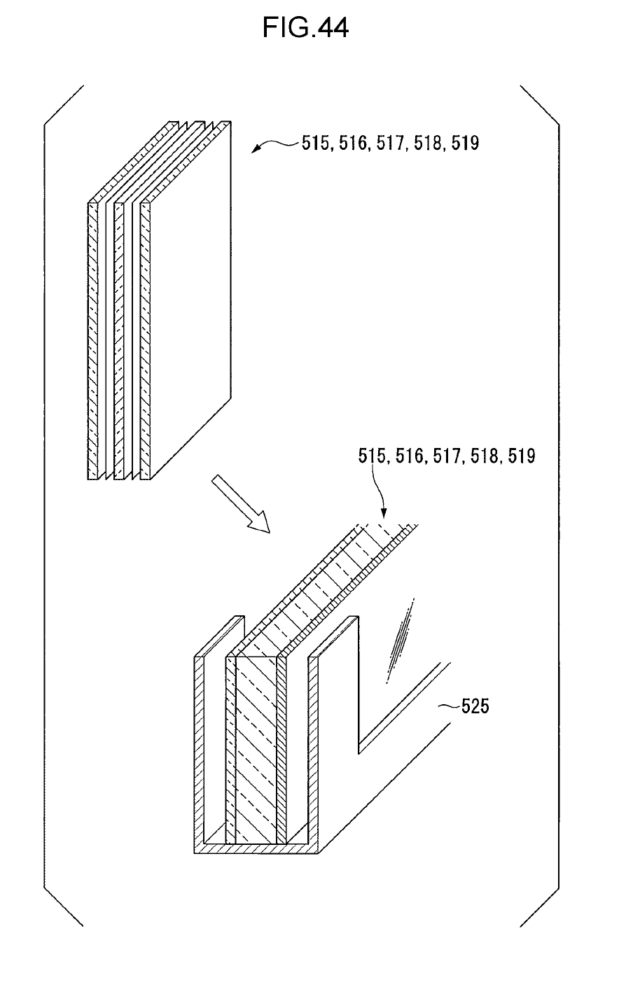

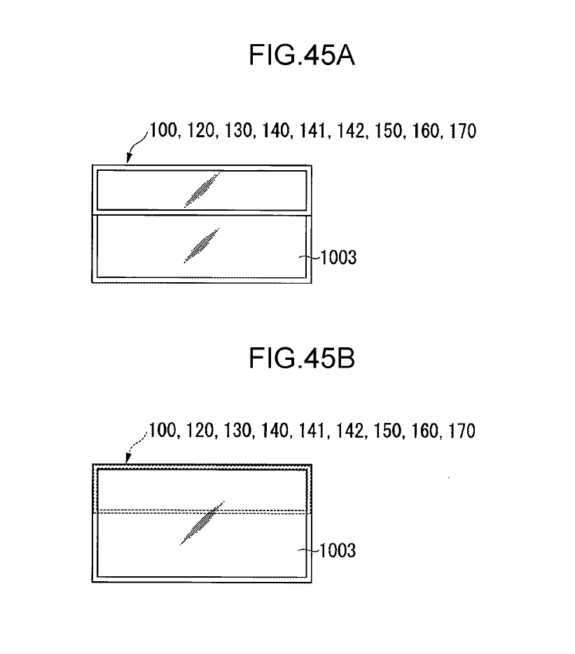

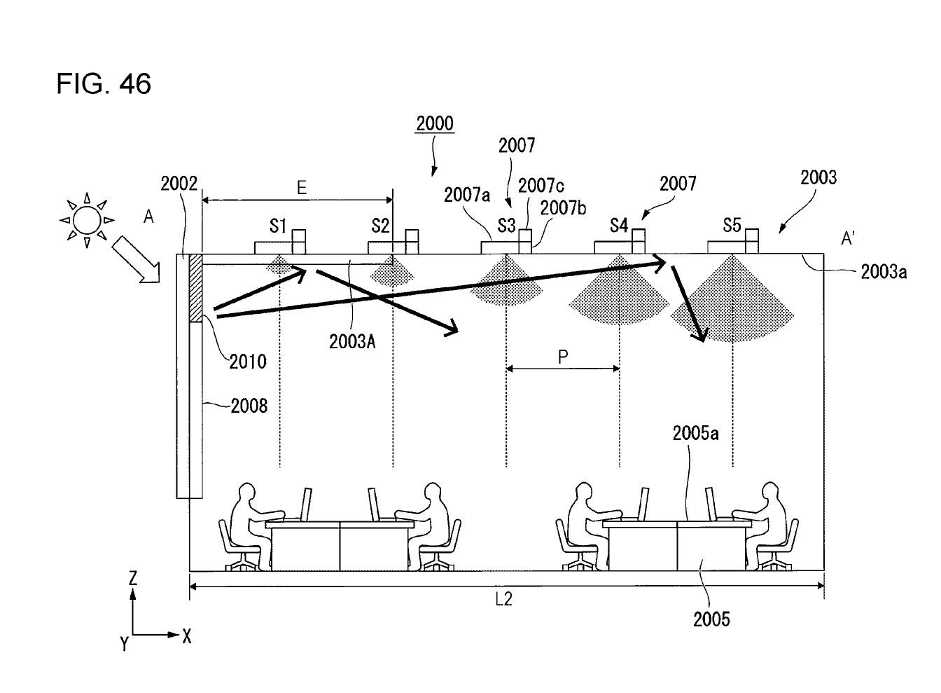

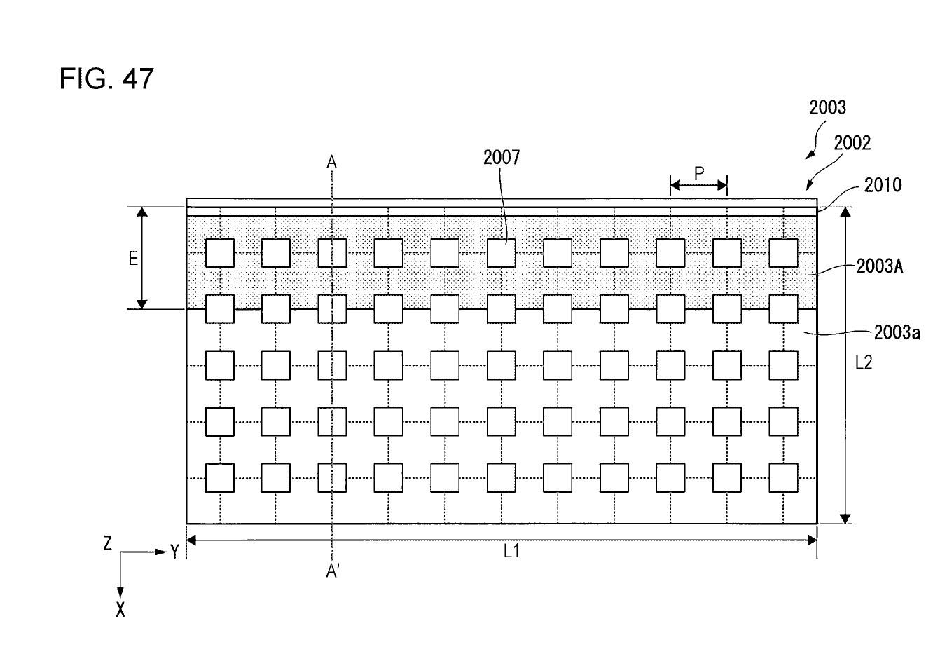

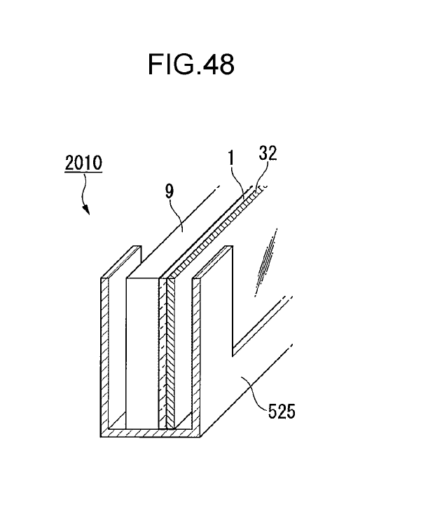

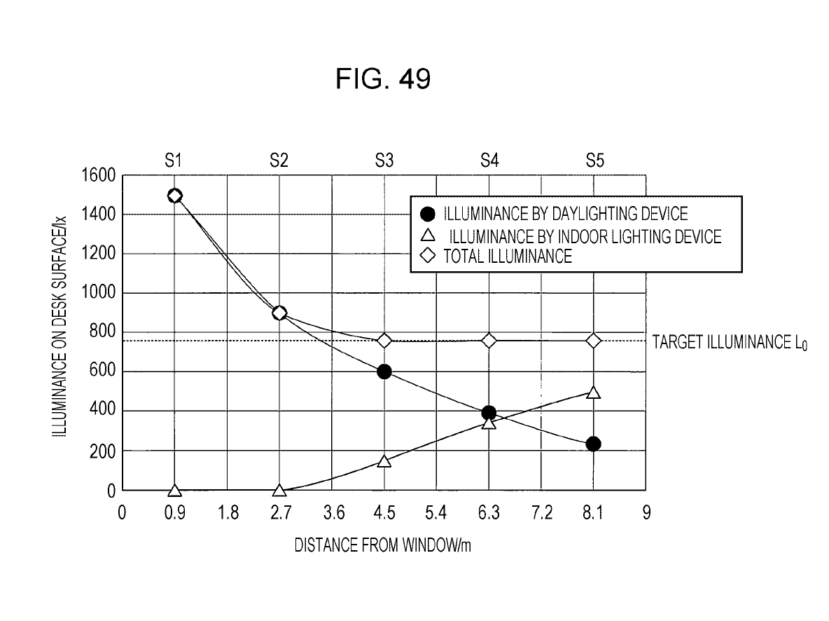

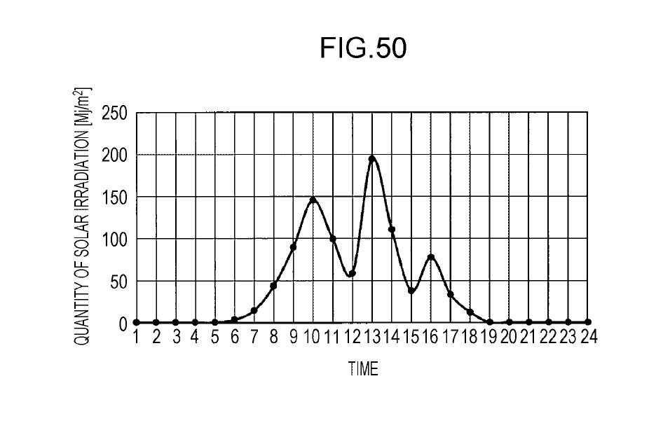

FIG. 23D is a fourth cross-sectional view for illustrating a configuration example of the daylighting device according to the fifth embodiment.

FIG. 24A is a cross-sectional view for illustrating a schematic configuration of a daylighting device according to a sixth embodiment.

FIG. 24B is a cross-sectional view for illustrating a modification example of the daylighting device according to the sixth embodiment.

FIG. 25 is a perspective view for illustrating a schematic configuration and an arrangement state of a daylighting device according to a seventh embodiment.

FIG. 26 is an enlarged diagram for illustrating a main part of the daylighting device according to the seventh embodiment.

FIG. 27 is a perspective view for illustrating a modification example of a daylighting panel according to the seventh embodiment.

FIG. 28 is a perspective view for illustrating a modification example of the daylighting panel according to the seventh embodiment.

FIG. 29 is a perspective view for illustrating a modification example of the daylighting panel according to the seventh embodiment.

FIG. 30 is a perspective view for illustrating a modification example of the daylighting panel according to the seventh embodiment.

FIG. 31 is a diagram for illustrating how to replace the window with another window.

FIG. 32 is a perspective view for illustrating an appearance of a blind in an eight embodiment.

FIG. 33 is a diagram for illustrating characteristics of the blind.

FIG. 34A is a diagram for illustrating a status where the blind is closed.

FIG. 34B is a diagram for illustrating a status where the blind is open.

FIG. 35A is a first diagram for illustrating a configuration example of a daylighting slat.

FIG. 35B is a second diagram for illustrating a configuration example of the daylighting slat.

FIG. 35C is a third diagram for illustrating a configuration example of the daylighting slat.

FIG. 36 is a perspective view for illustrating an appearance of a roll screen according to a ninth embodiment.

FIG. 37 is a cross-sectional view taken along the line E-E′ of the roll screen illustrated in the drawing.

FIG. 38A is a diagram for illustrating a status where the screen is closed.

FIG. 38B is a diagram for illustrating a status where the screen is open.

FIG. 39A is a first diagram for illustrating a configuration example of a daylighting screen.

FIG. 39B is a second diagram for illustrating a configuration example of the daylighting screen.

FIG. 39C is a third diagram for illustrating a configuration example of the daylighting screen.

FIG. 40 is a perspective view for illustrating a schematic configuration of a multi-layered glass (daylighting device) in a tenth embodiment.

FIG. 41 is a cross-sectional view for illustrating a schematic configuration of the multi-layered glass in the tenth embodiment.

FIG. 42A is a first diagram for illustrating a modification example of a multi-layered glass structure.

FIG. 42B is a second diagram for illustrating the modification example of the multi-layered glass structure.

FIG. 42C is a third diagram for illustrating the modification example of the multi-layered glass structure.

FIG. 42D is a fourth diagram for illustrating the modification example of the multi-layered glass structure.

FIG. 43 is a diagram for illustrating an arrangement region of a multi-layered window structure.

FIG. 44 is a diagram for illustrating a modification example of the multi-layered window structure.

FIG. 45A is a first diagram for illustrating a configuration in which the multi-layered window structure is held by a frame.

FIG. 45B is a second diagram for illustrating a configuration in which the multi-layered window structure is held by the frame.

FIG. 46 is a diagram for illustrating a room model including the daylighting device and a lighting control system and is a cross-section diagram taken along the line A-A′ of FIG. 47.

FIG. 47 is a plan view for illustrating a ceiling of the room model.

FIG. 48 is a diagram for illustrating a configuration example of the daylighting device to be used in the room model.

FIG. 49 is a graph for illustrating a relationship between illuminance of light (natural light) guided into indoors by the daylighting device and illuminance of light (lighting control system) by an indoor lighting device.

FIG. 50 is a graph for illustrating solar irradiance in Tokyo on a spring equinox day, and is an example of data stored in “Solar Irradiance Amount Database” of the New Energy and Industrial Technology Development Organization (NEDO).

### DESCRIPTION OF EMBODIMENTS

Hereinafter, embodiments of the present invention will be described with reference to drawings. In the following drawings to be used for the following description, in order to set each member to a recognizable size, scaling of each member is suitably changed.

### First Embodiment

A daylighting device of a first embodiment will be described with reference to the following drawings.

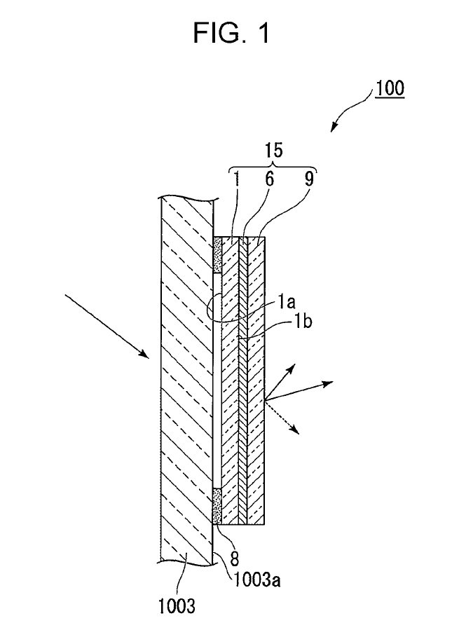

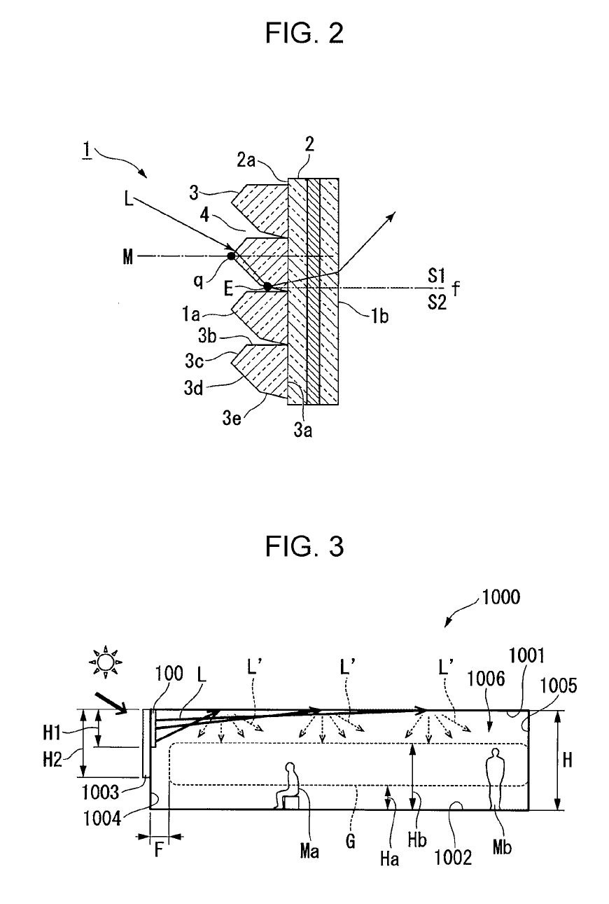

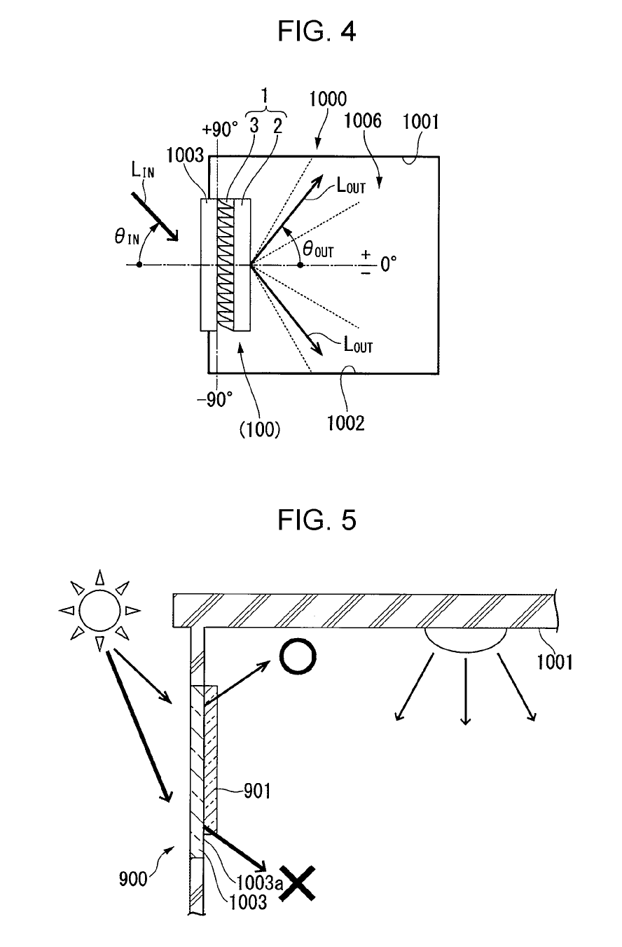

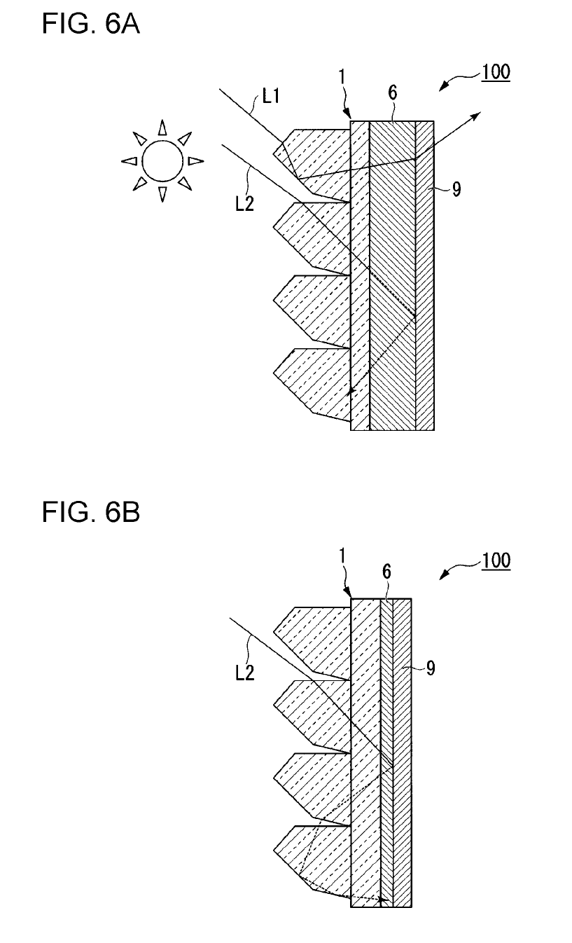

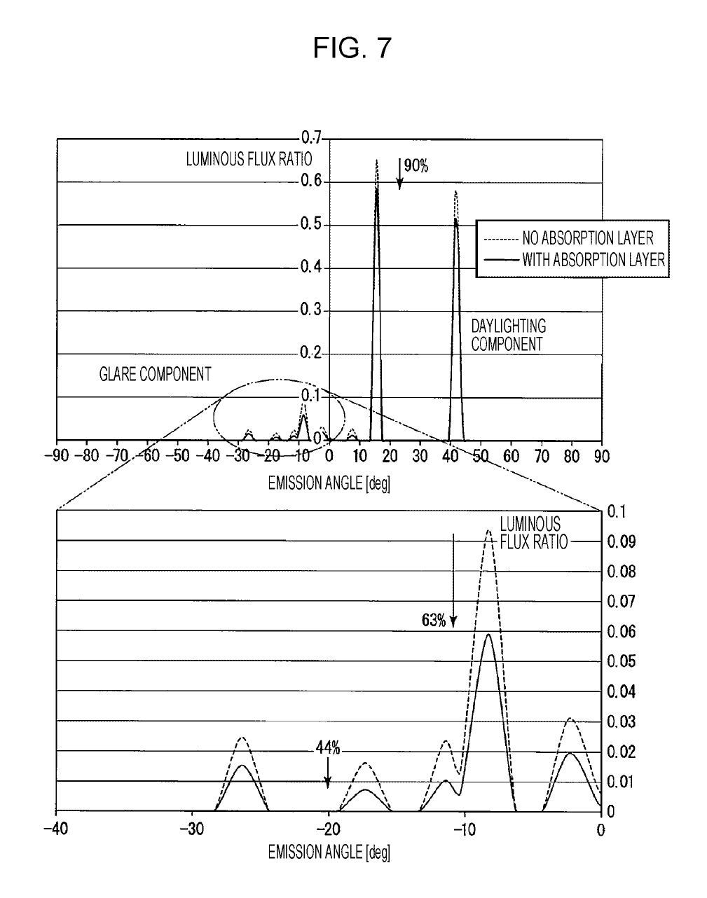

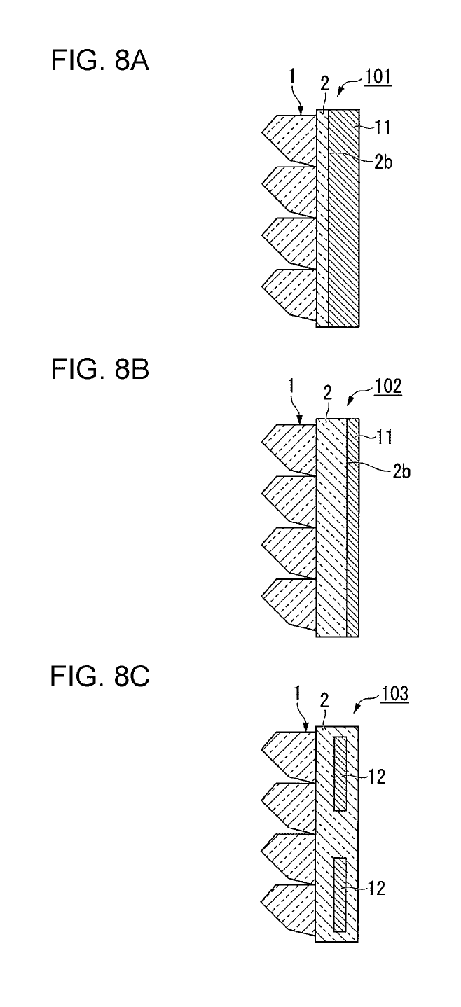

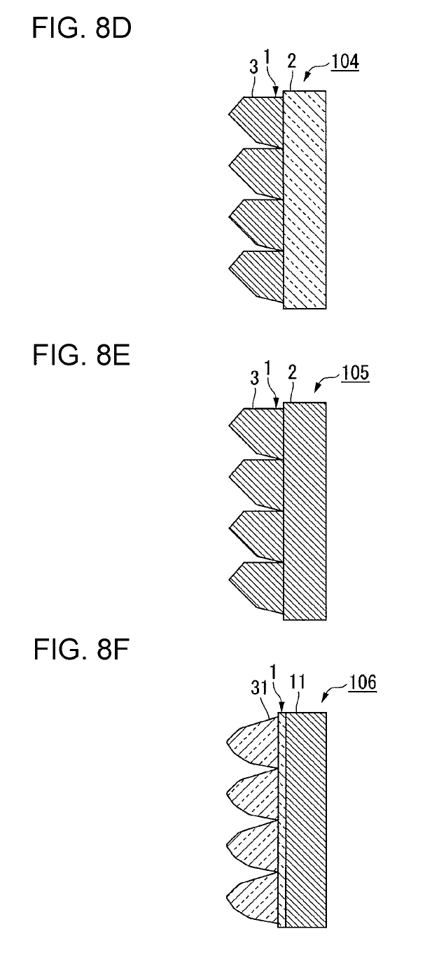

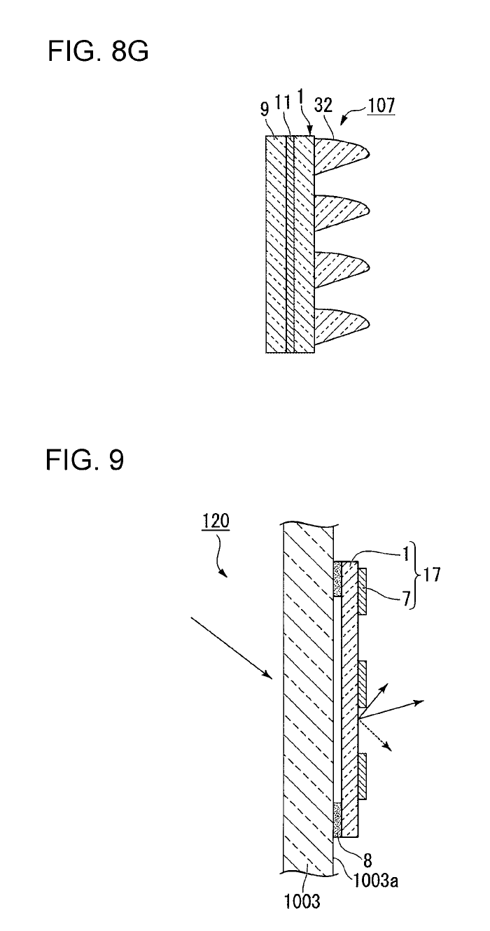

FIG. 1 is a cross-sectional view for illustrating a schematic configuration of a daylighting device according to the first embodiment of the present invention. FIG. 2 is an enlarged cross-sectional view for illustrating a main part of the daylighting device according to the first embodiment. FIG. 3 is a schematic diagram for illustrating an example of a room model. FIG. 4 is a diagram for illustrating definitions of an incident angle θ_{IN} of incident light Lm incident to the daylighting device and an emission angle θ_{OUT} of emission light L_{OUT} emitted from the daylighting device. FIG. 5 is a diagram for illustrating characteristics of a conventional daylighting device. FIGS. 6A and 6B are diagrams for illustrating characteristics of the daylighting device of the first embodiment. FIG. 7 is a graph for illustrating characteristics of the daylighting device according to the first embodiment. FIGS. 8A to 8G are modification examples of the daylighting device according to the first embodiment.

A daylighting device 100 of the first embodiment is an example of a daylighting device that brings sunlight into indoors in a state where the daylighting device 100 is attached to a window glass, for example.

As illustrated in FIG. 1, the daylighting device 100 of the first embodiment includes a daylighting film 15 including a daylighting member 1, a light absorption layer 6, and a transparent base material 9, and an adhesive layer 8, and is provided on an inner surface 1003a (indoor side surface) of a window glass (installation target) 1003 through the adhesive layer 8.

Here, a vertical direction of the plane is matched with a vertical direction (XY direction) of the daylighting member 1 which is attached to the window glass 1003.

As illustrated in FIG. 2, the daylighting member 1 includes a first substrate 2 having light transparency, the first substrate 2, and a plurality of daylighting units 3 which are provided on a first surface 2a of the first substrate 2 and has light transparency.

Gaps 4 are formed between the plurality of daylighting units 3. In the present embodiment, a microstructure side on which the plurality of daylighting units 3 are formed is a light incident surface 1a of the daylighting member 1 and the side where the microstructure is not formed is a light emitting surface 1b. The daylighting member 1 is used in a status where the light incident surface 1a side faces the window glass 1003 illustrated in FIG. 1.

As the first substrate 2, for example, a light-transmissive substrate formed of resins such as thermoplastic polymer, thermosetting resin, photopolymerizable resin, or the like is used. The light-transmissive substrate formed of an acrylic polymer, an olefin polymer, a vinyl polymer, a cellulose polymer, an amide polymer, a fluorine polymer, a urethane polymer, a silicone polymer, an imide polymer, or the like is used. Specifically, for example, the light-transmissive substrate such as a triacetyl cellulose (TAC) film, a polyethylene terephthalate (PET) film, a cycloolefin polymer (COP) film, a polycarbonate (PC) film, a polyethylene naphthalate (PEN) film, a polyethersulfone (PES) Film, or a polyimide (PI) film is preferably used.

In the present embodiment, as an example thereof, the PET film having a thickness of 100 μm is used. It is preferable that a total light transmittance of the first substrate 2 be equal to or higher than 90% according to HS K7361-1. Accordingly, a sufficient transparency can be obtained.

The thickness of the first substrate 2 is arbitrary and the shape thereof may be a film or a plate. In addition, a laminated structure in which a plurality of substrates are laminated may be used.

The daylighting unit 3 is configured of an organic material having light transparency and slow release, such as an acrylic resin, an epoxy resin, or a silicone resin, for example. A mixture formed of a transparent resin in which a polymerization initiator, a coupling agent, a monomer, an organic solvent and the like are mixed with these resins can be used. Further, the polymerization initiator may contain various additional components such as a stabilizer, an inhibitor, a plasticizer, a fluorescent whitening agent, a release agent, a chain transfer agent, or other photopolymerizable monomers.

In the present embodiment, the plurality of daylighting units 3 are formed on the first substrate 2 using a thermal imprinting method. As a method for forming the daylighting units 3, a method is not limited to the thermal imprinting method, and, a UV imprint method, a hot press method, an injection molding method, an extrusion molding method, a compression molding method, or the like may be used, for example. In a method such as a melt extrusion method or an embossing method, the first substrate 2 and the daylighting units 3 are integrally formed by the same resin.

In the present embodiment, as an example of the daylighting units 3, polymethylmethacrylate (PMMA) is used. It is preferable that a total light transmittance of the daylighting unit 3 be equal to or higher than 90% according to MS K7361-1. Accordingly, a sufficient transparency can be obtained.

As illustrated in FIG. 2, the daylighting unit 3 is elongated in a straight line shape in one direction (a direction perpendicular to the plane of FIG. 2) and forms a polygonal column shape in a cross-sectional shape orthogonal to a longitudinal direction. The daylighting unit 3 is a pentagon having five vertexes in a cross-sectional shape cut in a direction intersecting the longitudinal direction thereof and all inner angles are less than 180°. The plurality of daylighting units 3 are parallel to one side of the first substrate 2, each of which has a rectangular shape in the longitudinal direction, and are arranged in a width direction.

Specifically, the daylighting unit 3 has a polygonal columnar structure in which a shape of the both sides is an asymmetric shape and the cross-sectional shape is pentagon around a perpendicular M of a surface 3a passing through a vertex q farthest from the surface 3a facing the first surface 2a of the first substrate 2. That is, the volume of the lower portion including a surface 3d and a surface 3e is larger than the volume of the upper portion including a surface 3b and a surface 3c. In the present embodiment, the plurality of daylighting units 3 are arranged in a state where the large volume side (the surface 3d and surface 3e side) is unified at the lower side around the perpendicular M of the surface 3a in each of the daylighting units 3.

The cross-sectional shape of the daylighting unit 3 is not limited to a polygonal column shape such as a pentagon. That is, the daylighting unit 3 may have a shape that the shape of the both sides is asymmetric shape around an arbitrary perpendicular of the surface 3a. As the daylighting member 1, a prism structure having a cross-sectional shape of which the volume of the lower portion is equal to or greater than the volume of the upper portion may be continuously formed.

For the adhesive layer 8, a common optical adhesive is used. The refractive index of the adhesive layer 8 is preferably equal to the refractive index of the window glass 1003. Therefore, refraction does not occur at the interface between the daylighting member 1 and the window glass 1003.

The daylighting member 1 having such a configuration is attached to the inner surface 1003a of the window glass 1003 through the adhesive layer 8 such that the longitudinal direction of each of daylighting units 3 directed to the horizontal direction, and an arrangement direction of the plurality of daylighting units 3 is directed to the vertical direction.

The light absorption layer 6 is provided so as to cover entire a second surface 2b of the first substrate 2. The light absorption layer 6 is a member having light absorption characteristics for absorbing a part of light incident to each of the daylighting units 3 of the daylighting member 1, and in the light absorption layer 6, an effect of attenuating light intensity can be obtained. The light absorption layer 6 in the present embodiment has light transparency of less than 90%.

The transparent base material 9 is configured of a material having light transparency. The thickness of the transparent base material 9 is arbitrary and may be in a shape of a film or a plate. In addition, the transparent base material 9 may have a laminated structure in which a plurality of substrates are laminated.

The light that directly reaches from the sun enters to the window glass 1003, first, passes through the window glass 1003, and then, enters the daylighting device 100 obliquely from above. After, light L1 incident to the daylighting device 100 is refracted in the surface 3c of the daylighting units 3, the light L1 is totally reflected at the surface 3e and proceeds obliquely upward and is emitted from the second surface 2b of the first substrate 2 (the interface between the second surface 2b and the indoor space) toward the ceiling.

Here, for the sake of convenience of description, a point where an arbitrary one of light fluxes among light incident to the daylighting units 3 as illustrated in FIG. 2 is incident on the surface 3e (reflective surface) of the daylighting units 3 is defined as an incident point E. An imaginary straight line passing through the incident point E and orthogonal to the first surface 2a of the first substrate 2 is defined as a straight line f. Among two spaces having the horizontal plane (virtual plane) including the straight line f as the boundary, a space on the side where light L is incident to the incident point E is defined as a first space S1 and a space on the side where light L is not incident to the incident point E is defined as a second space S2.

For example, the light L incident from the surface 3c of the daylighting units 3 is totally reflected by the surface 3e of the daylighting units 3 and proceeds obliquely upward, that is, toward the first space Si side, and is emitted from the surface 3a of the daylighting units 3. The light L emitted from the daylighting units 3 passes through the first substrate 2 and travels from the daylighting member 1 toward the indoor ceiling. Since the light emitted from the daylighting member 1 toward the ceiling is reflected on the ceiling and illuminates the indoors, the light can be used instead of illumination light. Accordingly, in a case of using such a daylighting member 1, energy conservation effect can be expected to save the energy consumed by lighting equipment inside the building during the day.

### Room Model

Here, daylighting characteristics of the daylighting device 100 will be described using a room model 1000 illustrated in FIG. 3. The room model 1000 is, for example, a model assumed to be used in an office of the daylighting device 100. Specifically, the room model 1000 illustrated in FIG. 3 is imitative of a case where the outdoor light L enters indoors 1006 which is surrounded by a ceiling 1001, a floor 1002, a front side wall 1004 to which the window glass 1003 is attached, and a back side wall 1005 facing the front side wall 1004 through the window glass 1003 from obliquely above. The daylighting device 100 is attached to the upper portion side of the inner surface of the window glass 1003.

In the room model 1000, a height dimension (a dimension from the ceiling 1001 to the floor 1002) H of the indoors 1006 is set to 2.7 m, a vertical dimension H2 of the window glass 1003 is set to 1.8 m from the ceiling 1001, and a vertical dimension H1 of the daylighting member 1 is set to 0.6 m from the ceiling 1001.

In the room model 1000, there are a person Ma sitting on a chair in the indoors 1006 and a person Mb standing on the floor 1002 in the back of the indoors 1006. A height lower limit Ha of the eyes of the person Ma sitting on the chair is set to 0.8 m from the floor 1002, and a height upper limit Hb of the eyes of the person Mb standing on the floor 1002 is set to 1.8 m from the floor 1002.

A region G (hereinafter, referred to as a glare region) at which the persons Ma and Mb in the indoors 1006 feel dazzle is in a range of the heights Ha and Hb of the eyes of the persons Ma and Mb in the indoors. A region F in which the outdoor light L is directly radiated through the lower portion side of the window glass 1003 to which the daylighting member 1 is not attached is provided vicinity of the window glass 1003 of the indoors 1006. The region F is set to be in the range of 1 m from the front side wall 1004. Accordingly, the glare region G is in a range from a position 1 m apart from the front side wall 1004 excluding the region F to the back side wall 1005 among the height range from 0.8 m to 1.8 m from the floor 1002.

The glare region G is a region which is defined based on the position of the eyes of the person in the region where the person moves. For example, if the indoors 1006 is brightly illuminated by the light travelling to the ceiling 1001 side, when the light reaching the glare region G is large, the person in the indoors 1006 tends to feel uncomfortable.

The daylighting member 1 of the present embodiment is capable of relatively increasing the illumination of the light directed to the ceiling 1001 while reducing the illumination of the light directed to the glare region G among the light L incident to the indoors 1006 through the window glass 1003. Light L′ reflected by the ceiling 1001 illuminates the indoors 1006 brightly over a wide range instead of illumination light. In this case, by turning off the lighting equipment of the indoors 1006, energy conservation effect can be expected to save the energy consumed by lighting equipment of the indoors 1006 during the day.

### Definitions of Incident Angle and Emission Angle

Next, definitions of an incident angle θ_{IN} of incident light LN incident to the daylighting device 100 and an emission angle θ_{OUT} of emission light L_{OUT} emitted from the daylighting device 100 will be described with reference to FIG. 4.

In FIG. 4, the daylighting member 1 is mainly illustrated among the daylighting device 100 and the other components are not described.

As illustrated in FIG. 4, in the incident angle θ_{IN} of the incident light Lm and the emission angle θ_{OUT} of the emission light L_{OUT}, an angle in a direction along a normal line of the daylighting device 100 (the first substrate 2 of the daylighting member 1) is defined as 0°, an angle in a direction directed to the ceiling 1001 is defined as positive (+), and an angle in a direction directed to the floor 1002 is defined as negative (−).

In the daylighting device 100 of the present embodiment, when the incident angle θ_{IN} of the incident light L_{IN} incident to each of the daylighting units 3 of the daylighting member 1 is in the range of 20°≦θ_{IN}≦50° to the normal line of the daylighting member 1, the emission angle θ_{OUT} of the emission light L_{OUT} emitted from the daylighting member 1 is in a range of 0°≦θ_{OUT}≦15° in the same side (+) as that of the incident light L_{IN} to the normal line of the daylighting member 1, and the illumination of the emission light L_{OUT} is set to be relatively high.

Among the light L incident to the indoors 1006 through the daylighting device 100 and the window glass 1003, it is possible to relatively increase the illumination of the light directed to the ceiling 1001 while reducing the illumination of the light directed to the glare region G or the illumination of the light directed to the floor 1002. That is, the light L incident to the indoors 1006 through the daylighting device 100 and the window glass 1003 can be efficiently radiated to the ceiling 1001. In addition, it is possible to radiate the light L directed to the ceiling 1001 to the back of the indoors 1006 without causing the persons Ma and Mb to feel dazzle in the indoors 1006.

Furthermore, the light L′ reflected by the ceiling 1001 illuminates the indoors 1006 brightly over a wide range instead of illumination light. In this case, by turning off the illumination equipment of the indoors 1006, energy conservation effect can be expected to save the energy consumed by lighting equipment of the indoors 1006 during the day.

In addition, as illustrated in FIG. 4, in the daylighting device 100 of the present embodiment, when a variation range of the incident angle θ_{IN} of the incident light L_{IN} is defined as Δθ_{IN} and the variation range of the emission angle θ_{OUT} of the emission light L_{OUT} is defined as Δθ_{OUT}, it is preferable that the relation of Δθ_{IN}>Δθ_{OUT} is satisfied in a range of 20°θ_{IN}≦50°.

In this case, a variation in an irradiation position of the indoors 1006 due to the altitude changes in the sun can be suppressed. In addition, the light L directed to the ceiling 1001 can be radiated to the back of the indoors 1006 for a long time. Accordingly, further energy saving effect can be expected.

FIG. 5 is a diagram for illustrating characteristics of a conventional daylighting device.

As illustrated in FIG. 5, a conventional daylighting device 900 is configured by including only a daylighting member 901 to be attached to the inner surface 1003a of the window glass 1003. The daylighting member 901 has a daylighting structure in which it is possible to causes a lot of light to be emitted toward the ceiling in the range of an arbitrary sun altitude (incident angle) and to causes less glare that makes the person in the indoors feel dazzle.

As daylighting performance in the daylighting device 900, optical characteristics that the light can be radiated to the wide range of the ceiling toward the back of the indoors from the vicinity of the window and does not radiate glare that makes the person in the indoors fell dazzle is preferable. However, there is no daylighting device 900 that satisfies the above-described characteristics at any sun altitude and it is limited to only an arbitrary sun altitude (incident angle) range.

On the other hand, when the latitude and orientation of the window in which the daylighting device 900 is installed changes, the incident angle of the sunlight incident to the daylighting device 900 changes overall. Accordingly, in the daylighting device 900 which is formed on the premise of an arbitrary sun altitude cannot exert its performance sufficiently.

In this case, the daylighting performance that the sunlight is emitted toward the indoor ceiling is deteriorated due to the difference in the latitude or orientation of the building (window), the inclination of the installation location of the daylighting device 900, or the like, or the person in the indoors feels uncomfortable dazzle. That is, in the light emitted from the conventional daylighting device 900, there is an emission light capable of radiating the wide range of the ceiling and an emission light that becomes glare which makes the person in the indoors feel dazzle. As illustrated in FIG. 5, the light that does not contribute to daylighting is guided inside the daylighting member 1, and then emitted to an unintended direction to become glare.

FIGS. 6A and 6B are diagrams for illustrating characteristics of the daylighting device of the first embodiment.

The daylighting device 100 of the present embodiment has a configuration in which the light absorption layer 6 is disposed on the light emission side of the daylighting member 1 having favorable daylighting characteristics at an arbitrary sun altitude (incident angle).

Light L1 of the component which contributes to daylighting toward the ceiling direction among the light incident to the daylighting device 100 is passed through the light absorption layer 6 only once and emitted.

With respect to this, the light L2 (hereinafter, also referred to as “glare component light”) directed to the glare region guided through the inside the daylighting device 100 and emitted in a direction of the person's eyes is reflected at the interface between the light absorption layer 6 and the transparent base material 9 and passed through the light absorption layer 6 in a plural times as illustrated in FIG. 6B. The guide distance of the daylighting from the daylighting member 1 to the daylighting to be emitted is longer than the light contributing to daylighting. Attenuation efficiency of the intensity of the light changes depending on the optical path length. Therefore, as the optical length becomes longer, the light intensity attenuates.

In this manner, in the daylighting device 100 of the present embodiment, it is possible to absorb the daylighting guided inside the daylighting member 1 in the light absorption layer 6 to weaken the light intensity. Since the light intensity of the glare component is weakened, it is difficult for the person in the indoors to feel dazzle, even if the light emitted to the indoors, and there is no uncomfortable feeling. Accordingly, it is possible to secure the illuminance and good indoor environment in which glare is suppressed.

FIG. 7 is a graph for illustrating characteristics of the daylighting device according to the first embodiment. In FIG. 7, a graph indicated by a solid line illustrates a ratio of the daylighting component and the glare component in a case of including the light absorption layer and a graph indicated by a broken line illustrates a ratio of the daylighting component and the glare component in a case of excluding the light absorption layer.

Here, the glare component is a component whose emission angle is close to 0° and, for example, a component whose emission angle is in the range of 0° to −30°.

As illustrated in FIG. 7, it is found that the glare component in the emission light is decreased in the daylighting device 10 of the present invention including the light absorption layer than the conventional daylighting device excluding the light absorption layer.

Specifically, in the present embodiment, by providing the light absorption layer 6 having light transmittance of 90%, the daylighting component is attenuated to 90% as compared with the configuration without the light absorption layer 6. With respect to this, the glare component is considerably attenuated to 44% to 63%.

In this manner, since it is possible to attenuate the light intensity of the glare component at a ratio larger than the attenuation of the daylighting component by providing the light absorption layer 6, a comfortable daylighting environment where the person in the indoors does not feel dazzle can be provided.

In addition, a member having anisotropic scattering characteristics for scattering light of the room in the vertical direction or a member capable of cutting only light of a specific wavelength such as ultraviolet rays and infrared rays can be appropriately used in combination instead of the transparent base material 9.

### Modification Example of Daylighting Film in First Embodiment

FIGS. 8A to 8G are cross-sectional views illustrating the modification examples of the daylighting device of the first embodiment.

Daylighting films 101 and 102 illustrated in FIGS. 8A and 8B include a light absorption member 11 having light absorbing properties on the light emission side of the daylighting member 1. The light absorption member 11 is provided through the adhesive layer (not illustrated) on the second surface 2b of the first substrate 2 in the daylighting member 1. As the light absorption member 11, a substrate having a thickness thicker than the first substrate 2 as illustrated in FIG. 8A may be used and a film material thinner than the first substrate 2 as illustrated in FIG. 8B may be used.

As in the daylighting film 103 illustrated in FIG. 8C, the daylighting member 1, the plurality of light absorption layers 12, and the transparent base material 9 may be mainly configured. The plurality of light absorption layers 12 are embedded inside the first substrate 2 in the daylighting member 1 at intervals along the arrangement direction of the daylighting units 3 in the daylighting member 1.

As a daylighting film 104 illustrated in FIG. 8D, a film formed of the daylighting member 1 partially having the light absorption characteristics may be used. Here, the plurality of daylighting units 3 having the daylighting performance has the light absorption characteristics and is formed of a material colored with a prescribed color.

As a daylighting film 105 illustrated in FIG. 8E, a film may be formed of a daylighting member having the light absorption characteristics as a whole. Here, not only the plurality of daylighting units 3 having daylighting performance but also the first substrate 2 supporting a plurality of daylighting units 3 has the light absorption characteristics.

As daylighting films 106 and 107 illustrated in FIGS. 8F and 8G, the daylighting member 1 having daylighting units 31 and 32 having a curved surface cross-sectional shape orthogonal to the longitudinal direction may be appropriately combined with a member having light absorption characteristics.

As described above, it is possible to obtain the same effect as that of the above-described daylighting device 100 of the first embodiment by using the material which absorbs visible light for at least a part of the members configuring the daylighting film.

### Second Embodiment

A daylighting device of a second embodiment will be described with reference to the following drawings.

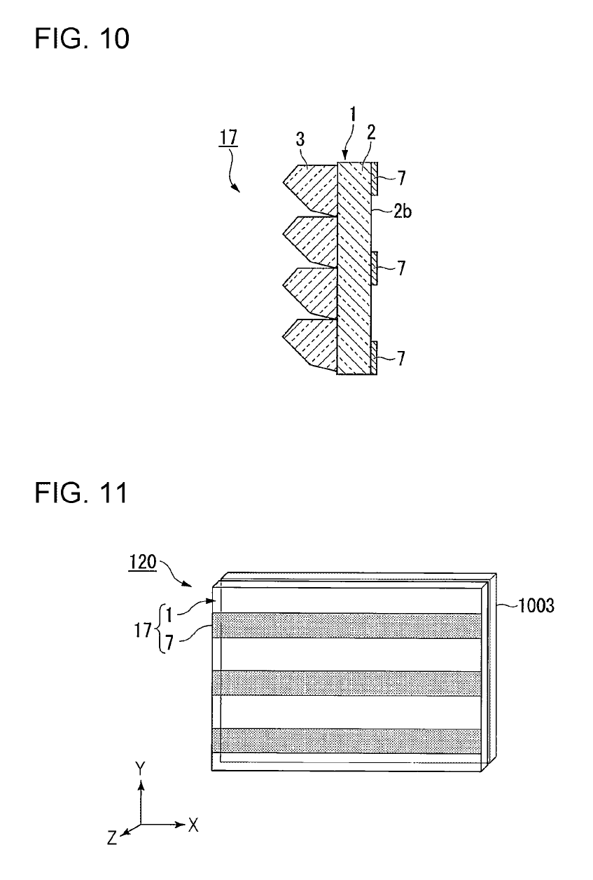

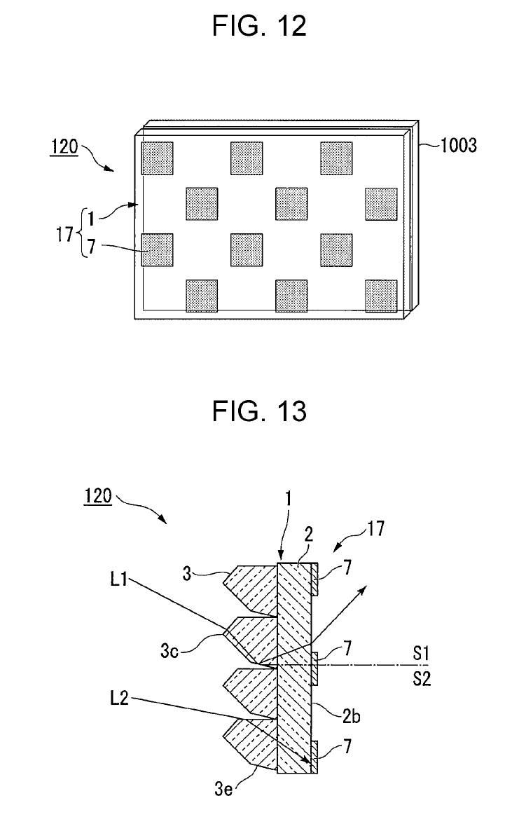

FIG. 9 is a cross-sectional view for illustrating a schematic configuration of the daylighting device according to the second embodiment. FIG. 10 is an enlarged cross-sectional view for illustrating a main part of the daylighting device according to the first embodiment. FIG. 11 is a perspective view for illustrating an arrangement example of a plurality of light shielding layers in the daylighting device. FIG. 12 is a perspective view for illustrating another example in the arrangement of the plurality of light shielding layers.

A basic configuration of a daylighting device 120 of the present embodiment to be described is substantially the same as that of the above-described first embodiment, but differs in that the light shielding layer is included. Accordingly, in the following description, the difference components will be described in detail, and the description of common portions will be omitted. In addition, in each drawing used for description, the same reference numerals are given to configuration elements common to those in FIGS. 1 to 4.

As illustrated in FIG. 9, the daylighting device 120 according to the second embodiment includes a daylighting film 17 including the daylighting member 1 and a plurality of light shielding layers (light absorption layer) 7 and the adhesive layer 8 and is provided on the inner surface 1003a (the indoor side surface) of the window glass 1003 through the adhesive layer 8. The light shielding layer 7 is included in the light absorption layer in the present invention.

Since the daylighting member 1 has the same configuration as that of the previous embodiment, the description thereof will be omitted.

As illustrated in FIG. 10, the plurality of light shielding layers 7 are provided on the second surface 2b of the first substrate 2 in the daylighting member 1, and disposed at a prescribed interval in the arrangement direction of the daylighting unit 3. The plurality of light shielding layers 7 are configured by a light shielding pattern formed of a material having light shielding properties of substantially 0% of light transparency, for example, an organic material such as black resist or a metal material such as chrome. In addition, the organic material configuring the light shielding layer 7 may contain an ultraviolet ray absorbing substance which absorbs the ultraviolet ray.

As illustrated in FIG. 11, the light shielding layer 7 of the present embodiment has a long and thin shape along the extending direction (X direction) of the daylighting units 3. However, it is not limited thereto, for example, as illustrated in FIG. 12, it may be a square as viewed from the normal direction of the first substrate 2. The number and the arrangement position of the light shielding layers 7 may be changed according to the structure of the daylighting device 120 such as size of the daylighting unit 3 or the first substrate 2.

FIG. 13 is a diagram for illustrating characteristics of the daylighting device according to the second embodiment.

As illustrated in FIG. 13, a plurality of light shielding layers 7 are disposed on the light emitting side of the daylighting member 1, in the daylighting device 120 of the present embodiment. Among the light incident to the daylighting member 1, for example, the light L1 incident from the surface 3c of the daylighting units 3 is totally reflected on the surface 3e, travels obliquely upward, that is, toward the side of the first space S1 (FIG. 4), and is emitted from the second surface 2b side of the first substrate 2 toward the indoor ceiling through gaps between the light shielding layers 7.

On the other hand, among the light incident to the daylighting member 1, for example, the light L2 incident from the surface 3b of the daylighting units 3 passes through the daylighting units 3 and the first substrate 2 and is absorbed by the light shielding layer 7 passing. Since the sunlight enters from which surface of the daylighting units 3 differs depending on the sun altitude, the above-described optical path locus is an example.

Among the light incident to the daylighting member 1, in the emission light in which the travelling direction of the light in the daylighting units 3 is changed, and the light is directed obliquely downward, the light of the glare component that makes the person in the indoors feel dazzle is often included in many cases. Therefore, in the present embodiment, by providing a plurality of light shielding layers 7 partially on the light emission side of the daylighting device 120, it is possible to attenuate the light of the glare component entering the light shielding layer 7. Accordingly, it is possible to provide a comfortable daylighting environment that does not make the person in the indoors feel dazzle. In addition, since the daylighting device 120 of the present embodiment can emit light that does not contain the glare component toward the ceiling without substantially attenuating, it is possible to sufficiently use the sunlight to ensure an indoor bright environment.

### Modification Example of Daylighting Film in Second Embodiment

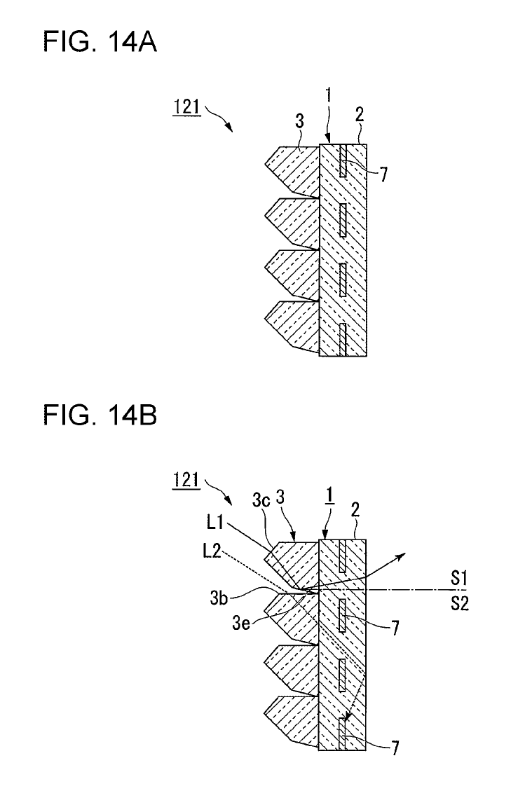

FIG. 14A is a cross-sectional view for illustrating a modification example of a daylighting film according to the second embodiment.

As in a daylighting film 121 illustrated in FIG. 14A, the daylighting member 1, the plurality of light shielding layers 7, and the transparent base material 9 may be mainly configured. The plurality of light shielding layers 7 are embedded inside the first substrate 2 in the daylighting member 1 at intervals along the arrangement direction of the daylighting units 3 in the daylighting member 1.

FIG. 14B is a diagram for illustrating characteristics of the daylighting film illustrated in FIG. 14A.

As illustrated in FIG. 14B, in the daylighting film 121, among the light incident to the daylighting member 1, for example, the light L1 incident from the surface 3c of the daylighting units 3 is totally reflected on the surface 3e, travels obliquely upward, that is, toward the side of the first space S1, and is emitted from the second surface 2b side of the first substrate 2 toward the indoor ceiling through gaps between the light shielding layers 7.

On the other hand, for example, the light L2 incident from the surface 3b of the daylighting units 3 passes the daylighting units 3, and is reflected according to the refractive index differences in the interface between the second surface 2b of the first substrate 2 and the indoor space, and is absorbed by the light shielding layer 7.

A part of the light which passed through the daylighting units 3 is directly absorbed by the light shielding layer 7 depending on the sun altitude.

As described above, in the daylighting film 121, the light to be totally reflected on the interface between the second surface 2b of the first substrate 2 and the indoor space among the incident light is difficult to be emitted to the indoor side. Since in such a daylighting including the glare component, the guide distance from the daylighting film 121 to the daylighting member to be emitted is longer than the light contributing to the daylighting, it is possible to attenuate light considerably than the light contributing to the daylighting. In addition, since the daylighting is guided while changing the travelling direction in the daylighting film 121, the probability that light enters the light shielding layer 7 is higher than the light contributing to the daylighting.

In this manner, among the light to be emitted from the daylighting film 121, it is possible to greatly reduce the light of the glare component and to greatly attenuate the light of the glare component.

### Other Modification Examples of Daylighting Film in Second Embodiment

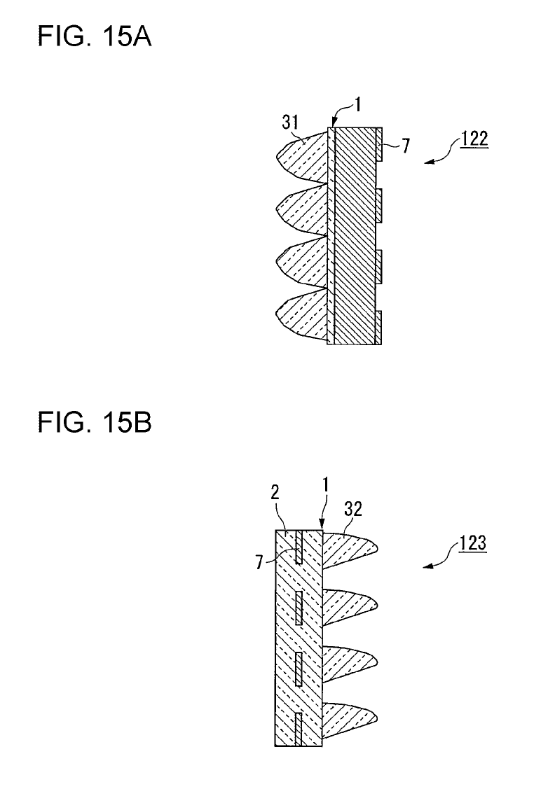

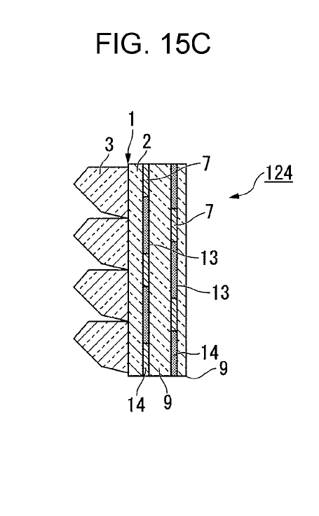

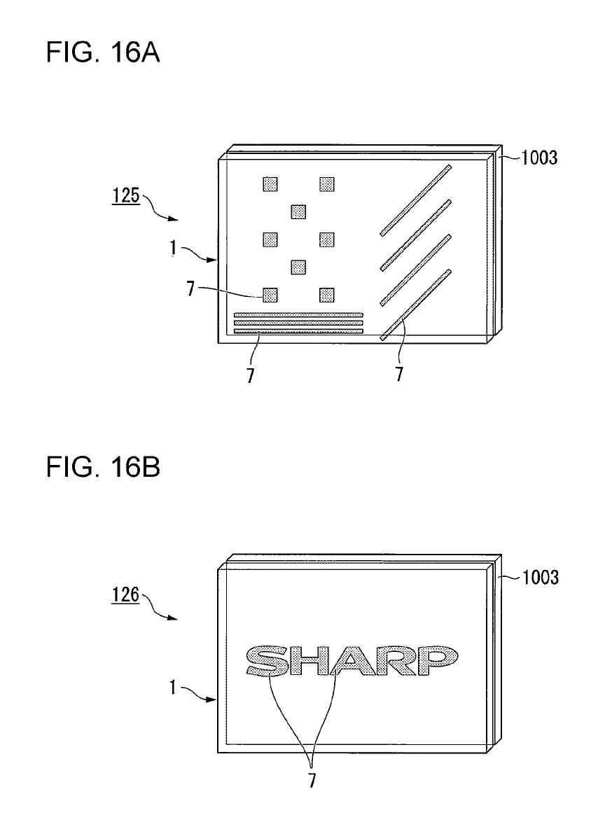

FIGS. 15A to 15C and FIGS. 16A and 16B are cross-sectional views illustrating other modification examples of the daylighting film according to the second embodiment.

As daylighting films 122 and 123 illustrated in FIGS. 15A and 15B, a plurality of light shielding layers 7 may be provided on the daylighting member 1 including the daylighting units 31 and 32 of which the cross-sectional shape orthogonal to the longitudinal direction is a curved surface.

As a daylighting film 124 illustrated in FIG. 15C, the light shielding function layer 14 having the plurality of light shielding layers 7 and the transparent base material 9 may be alternately laminated on the second surface 2b of the first substrate 2. The plurality of light shielding layers 7 in each of the light shielding function layers 14 are disposed at a position which does not overlap the light shielding layer 7 of the other light shielding function layer 14 when viewed from the normal direction of the first substrate 2. Between the daylighting member 1 and each of the transparent base materials 9 are adhered to each other through an adhesive layer 13 in each light shielding function layer 14.

The numbers of the light shielding function layer 14 and the transparent base material 9 are not limited to the above-described number.

As a daylighting film 125 illustrated in FIG. 16A, the shape of each light shielding layer 7 as viewed from the normal direction may not be unified. The number, the shape, the position, and the like of the light shielding layer 7 can be appropriately changed. For example, as a daylighting film 126 illustrated in FIG. 16B, an arbitrary character string such as “SHARP” may be configured by the plurality of light shielding layers 7. Therefore, it is possible to impart design characteristics to the daylighting device and to use the daylighting device for advertisement panels, signboards, and the like.

### Third Embodiment

A daylighting device of a third embodiment will be described with reference to the following drawings.

A basic configuration of a daylighting device of the present embodiment to be described is substantially the same as that of the above-described each embodiment, but differs in that a configuration that the light absorption film can be retrofitted to the daylighting member is provided. Accordingly, in the following description, the different components will be described in detail, and the description of common portions will be omitted. In addition, in each drawing used for description, the same reference numerals are given to configuration elements common to those in FIGS. 1 to 4.

### Light Absorption Film Attached Daylighting Device

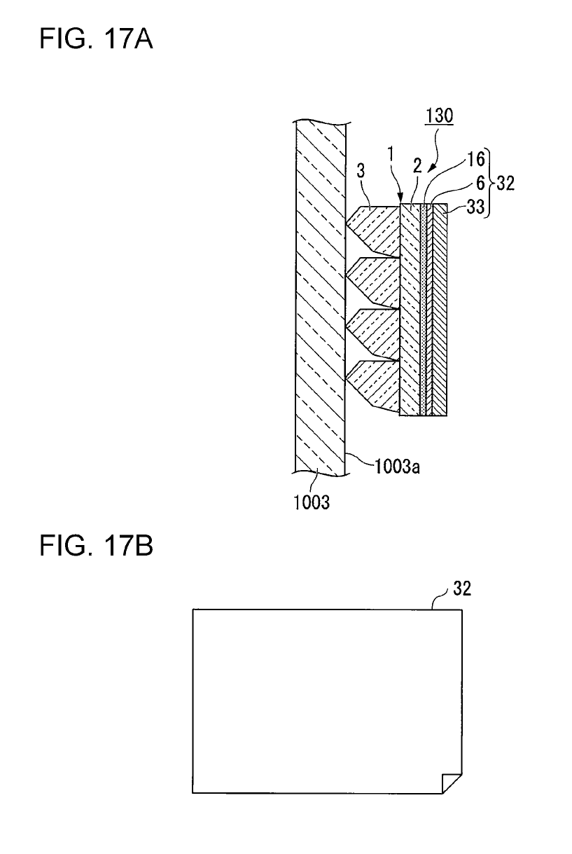

FIG. 17A is a cross-sectional view for illustrating a schematic configuration of a daylighting device having light absorption characteristics according to a third embodiment, and FIG. 17B is a plan view for illustrating a schematic configuration of a light absorption film.

A daylighting device 130 in the present embodiment is configured by including the daylighting member 1 and a light absorption film (light absorption layer) 32 and the light absorption film 32 is detachably attached to the daylighting member 1. The light absorption film 32 is included in the light absorption layer in the present invention. Since the daylighting member 1 has the same configuration as that of the previous embodiment, the description thereof will be omitted.

The light absorption film 32 is configured by including a transparent film 33, the light absorption layer 6, and an optical adhesive layer 16.

The transparent film 33 is formed of a transparent film material having substantially the same size as that of the first substrate 2 of the daylighting member 1. The light absorption layer 6 is provided on the surface of the transparent film 33. The material of the light absorption layer 6 is not particularly limited as long as the material has light absorbing properties. The optical adhesive layer 16 is provided on the surface of the light absorption layer 6 that is, on a surface opposite to the transparent film 33. The optical adhesive layer 16 has good adhesiveness to the daylighting member 1 and has an adhesive force that allows the user to easily remove the light absorption film 32 from the daylighting member 1.

### Light Shielding Film Attached Daylighting Device

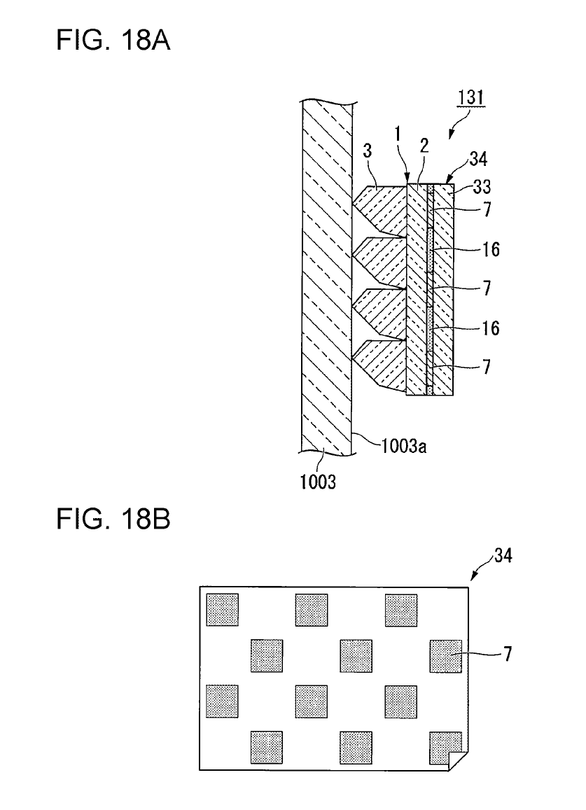

FIG. 18A is a cross-sectional view for illustrating a schematic configuration of the daylighting device having light shielding characteristics according to the third embodiment, and FIG. 18B is a plan view for illustrating a schematic configuration of a light shielding film.

A daylighting device 131 in the present embodiment is configured by including the daylighting member 1 and a light shielding film (light absorption layer) 34 and the light shielding film 34 is detachably attached to the daylighting member 1. The light shielding film 34 is included in the light absorption layer in the present invention.

The light shielding film 34 is configured by including the transparent film 33, the plurality of light shielding layers 7, and the plurality of optical adhesive layers 16.

The plurality of light shielding layers 7 are provided on the surface of the transparent film 33 and disposed in parallel in one direction with a prescribed interval therebetween. The plurality of optical adhesive layers 16 are provided on the surface of each of the light shielding layers 7. As described above, the plurality of optical adhesive layers 16 also have adhesiveness to the daylighting member 1 and have the adhesive force that allows the user to easily remove the light absorption film 32 from the daylighting member 1.

The configuration is not limited to the above-described configuration, for example, the light absorption layer 6 and the plurality of light shielding layers 7 may be formed using the material having the adhesiveness.

In addition, as the light shielding film 34, a film in which the plurality of light shielding layers 7 are integrally formed in the transparent film 33 may be used.

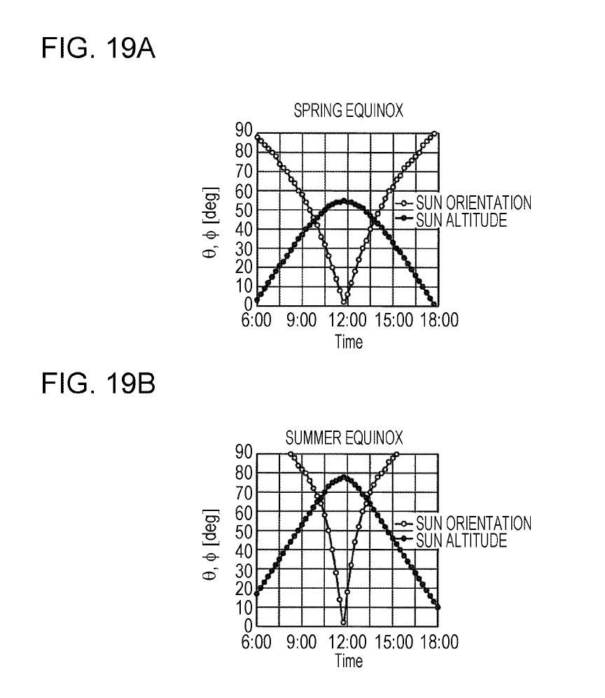

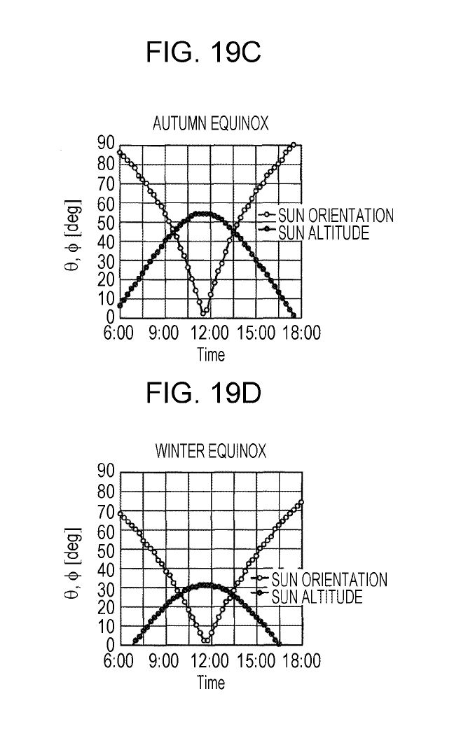

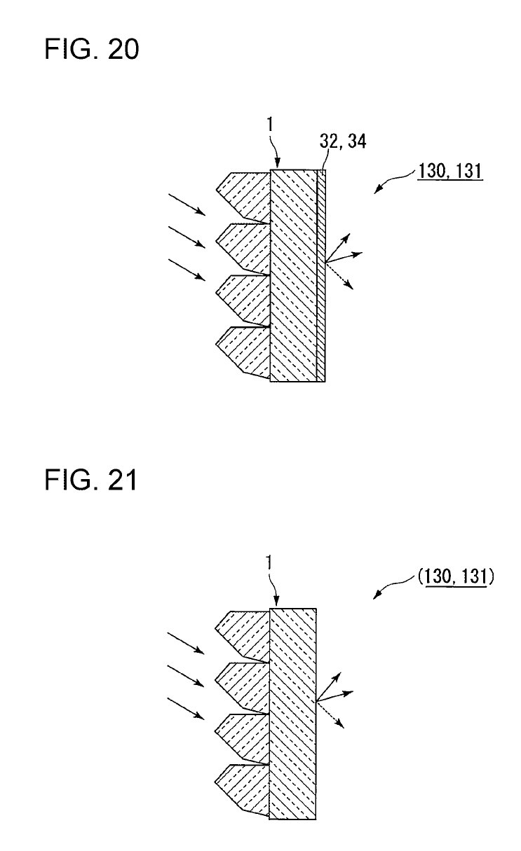

FIGS. 19A to 19D are graphs illustrating sun seasonal variations in which a horizontal axis indicates a time, and a vertical axis indicates a sun altitude and sun orientation θ, φ deg. FIG. 19A illustrates the spring equinox, FIG. 19B illustrates the summer equinox, FIG. 19C illustrates the autumn equinox, and FIG. 19D illustrates the winter equinox. The graph indicated by o in the drawings indicates the sun orientation and the graph indicated by · indicates the sun altitude. FIGS. 20 and 21 are diagrams illustrating usage examples of the daylighting device.

As illustrated in FIGS. 19A to 19D, the altitude or the orientation of the sunlight is greatly varied depending on the season or the time. Therefore, when the angle of the incident light to the daylighting device changes, the light emission characteristics also changes and the light amount of the glare component changes.

Among the daylighting devices 130 and 131 of the present embodiment illustrated in FIGS. 17A, 17B, 18A, and 18B, the daylighting member 1 is always attached to the window glass through the adhesive layer.

In the season (sun position) in which the light of the glare component increases in this states, as illustrated in FIG. 20, by using the light absorption film 32 or the light shielding film 34 in a state where the light absorption film 32 or the light shielding film 34 is attached to the daylighting member 1, the light including the glare component is attenuated. Accordingly, it is possible to reduce the dazzle sensed by the person in the indoors.

On the other hand, in the season (the sun position) in which the light of the glare component decreases, as illustrated in FIG. 21, the light absorption film 32 or the light shielding film 34 is removed from the daylighting member 1 and only the daylighting member 1 is used. Accordingly, it is possible to obtain the brighter and more comfortable indoor environment without attenuating the light of the daylighting component.

In this case, in the daylighting devices 130 and 131, since the light absorption film 32 or the light shielding film 34 is detachably attached to the daylighting member 1, the light absorption film 32 or the light shielding film 34 can be attached freely when needed. That is, among the emission light emitted from the daylighting devices 130 and 131, the presence or absence of the light absorption film 32 or the light shielding film 34 can be appropriately selected according to the season when the light of the glare component increases and the season when the glare component decreases.

### Fourth Embodiment

A daylighting device of a fourth embodiment will be described with reference to the following drawings.

In the previous embodiments, the daylighting device to be used by attaching, to the window glass 1003, the microstructure side on which the plurality of daylighting units 3 in the daylighting member 1 are formed is described. However, a configuration of the daylighting device to be used by attaching the side opposite to the microstructure of the daylighting member 1 to the window glass 1003 will be described.

FIGS. 22A to 22C are diagrams illustrating configuration examples of the daylighting device according to a fourth embodiment.

As illustrated in FIGS. 22A to 22C, each of daylighting devices 140, 141, and 142 in the present embodiment are configured such that the first substrate 2 side of the daylighting member 1 is attached to the window glass 1003. The daylighting device is used in a state where each daylighting units 3 in the daylighting member 1 is directed to the outdoor side, but it is not limited thereto. The daylighting device may be installed in either the outdoor side or the indoor side depending on the cross-sectional shape of the daylighting units 3.

The daylighting device 140 illustrated in FIG. 22A is configured by including the daylighting member 1 and a light absorption layer 41 having adhesiveness, and the daylighting member 1 is attached to the window glass 1003 through the light absorption layer 41. The light absorption layer 41 is not particularly limited as long as the light absorption layer 41 contains the material having the light absorbing properties and adhesiveness.

The daylighting device 141 illustrated in FIG. 22B is configured by including the daylighting member 1 and a plurality of light absorption layers 42, and the daylighting member 1 is attached to the window glass 1003 through the plurality of light absorption layers 42 having adhesiveness. The plurality of light absorption layers 42 are disposed on the second surface 2b of the first substrate 2 of the daylighting member 1 at a prescribed interval.

The daylighting device 142 illustrated in FIG. 22C is configured by including the daylighting member 1 and a plurality of light shielding layers 43, and the daylighting member 1 is attached to the window glass 1003 through the plurality of light shielding layers 43 having adhesiveness. The plurality of light shielding layers 43 are disposed on the second surface 2b of the first substrate 2 of the daylighting member 1 at a prescribed intervals.

In each of the daylighting device 140, 141, and 142 in the present embodiment, it is possible to attach the daylighting member to the window glass 1003 without an adhesive layer by using the light absorption layers 41 and 42 or the light shielding layers 43 having adhesiveness. Also, in each of the daylighting device 140, 141, and 142 of the present embodiment, the light of the glare component passing through the window glass 1003 can be attenuated by the light absorption layers 41 and 42 or the light shielding layers 43, and it is possible to provide the indoor environment in which a person in the indoors does not feel dazzle.

### Fifth Embodiment

A daylighting device of a fifth embodiment will be described with reference to the following drawings.

FIGS. 23A and 23B are cross-sectional views illustrating configuration examples of a daylighting device according to a fifth embodiment.

A basic configuration of a daylighting device 150 of the present embodiment to be described is substantially the same as that of the above-described embodiment, but differs in that both the light absorption layer and the light shielding layer are provided. Accordingly, in the following description, the different components will be described in detail, and the description of common portions will be omitted. In addition, in each drawing used for description, the same reference numerals are given to configuration elements common to those in FIGS. 1 to 4.

The daylighting device 150 illustrated in FIG. 23A is configured by including the daylighting member 1, the light absorption layer 6, the transparent base material 9, and the light shielding layer 7. On the light emission side of the daylighting member 1, the light absorption layer 6, the transparent base material 9, and the light shielding layer 7 are disposed in this order. For example, the light shielding layer 7 is formed using the same material as that of the light absorption layer 6, and the light shielding properties may be increased by increasing the thickness of the light absorption layer 6.

In the daylighting device 150, among the light incident to the daylighting member 1, the light including the glare component is absorbed by the light shielding layer 7. Among the light passed through gaps between the adjacent light shielding layers 7 without being incident to the light shielding layer 7, the light incident to the light absorption layer 6 at an angle equal to or less than the critical angel is slightly attenuated in the light absorption layer 6, and then is emitted from the other transparent base material 9 side into the indoors. In addition, the light incident to the light absorption layer 6 at the angle equal to or greater than the critical angle is totally reflected in the interface between the light absorption layer 6 and the transparent base material 9 or the interface between the transparent base material 9 and the indoor space and guided into the daylighting device 100. Such a daylighting is attenuated by passing through the light absorption layer 6 plural times or is absorbed by the light shielding layer 7.

As the daylighting device 150 in the present embodiment, by adopting the configuration including both the light shielding layer 7 and the light absorption layer 6, it is possible to efficiently attenuate or reduce the light of the glare component or it is possible to provide the indoor environment with suppressed dazzle.

### Modification Example of Daylighting Device in Fifth Embodiment

As a daylighting device 151 illustrated in FIG. 23B, the transparent base material 9 may be omitted, and the light absorption layer 6 and the light shielding layer 7 may be disposed side by side.

As a daylighting device 152 illustrated in FIG. 23C, a configuration including the daylighting member 1, the light absorption layer 6, the plurality of light shielding layers 7, and the transparent base material 9 may be provided. The plurality of light shielding layers 7 may be embedded inside the first substrate 2 of the daylighting member 1.

As a daylighting device 153 illustrated in FIG. 23D, a configuration including the daylighting member 1, the light absorption layer 6, and a light shielding substrate 21 may be provided. The light shielding substrate 21 has a structure that the plurality of light shielding layers 7 are embedded inside a transparent base material 22.

### Sixth Embodiment

A daylighting device of a sixth embodiment will be described with reference to the following drawings.

FIG. 24A is a cross-sectional view for illustrating a schematic configuration of a daylighting device 160 according to the sixth embodiment.

The daylighting device 160 of the present embodiment to be described is different from the previous embodiment in that the daylighting device 160 includes a transparent base material having light absorbing properties. Accordingly, in the following description, the different components will be described in detail, and the description of common portions will be omitted. In addition, in each drawing used for description, the same reference numerals are given to configuration elements common to those in FIGS. 1 to 4.

As illustrated in FIG. 24A, the daylighting device 160 is configured by including the daylighting member 1 and a light-absorbing substrate 61. As the light-absorbing substrate 61, a transparent glass base material which is not colored is used. The light-absorbing substrate 61 is provided on the second surface 2b side of the first substrate 2 of the daylighting member 1 through an adhesive layer (not illustrated). In the daylighting device 160 of the present embodiment, the light-absorbing substrate 61 absorbs the light including the glare component.

According to the daylighting device 160 of the present embodiment, the light contributing to the daylighting can be emitted toward the ceiling without considerably being attenuated and the light of the glare component incident to the light-absorbing substrate 61 can be attenuated in the light-absorbing substrate 61. Accordingly, it is possible to reduce the dazzle to the person in the indoors.

### Modification Example of Daylighting Device in Sixth Embodiment

FIG. 24B is a cross-sectional view for illustrating a modification example of a daylighting device 161 according to the sixth embodiment.

As illustrated in FIG. 24B, the daylighting device 161 is configured by including the daylighting member 1 and a low emissivity glass (Low-E glass) 62. Since the low emissivity glass 62 is obtained by coating a low emissivity film 64 onto the surface of a glass substrate 63, the low emissivity glass 62 has a function of reflecting an infrared ray IR.

As the material of the low emissivity film 64, a metal material such as silver is used for tin oxide.

In the daylighting device 161, among the light incident to the daylighting member 1, and among the light refracted obliquely upward by the daylighting units 3, a part of light L3 including the infrared ray IR is reflected by the low emissivity film 64 of the low emissivity glass 62, and the other light L2 is emitted from a light emitting surface 62b of the low emissivity glass 62 toward the indoor ceiling.

The light including the glare component refracted obliquely downward in the daylighting units 3 includes a part of infrared light L4 to be reflected by the low emissivity film 64 and light L5 which is totally reflected at the interface between the glass substrate 63 and the indoor space passing through the low emissivity film 64 and confined inside the light-absorbing substrate 61.

The infrared light L4 guided to the inside the daylighting member 1 enters to the low emissivity glass 62 again after being guided, and is attenuated by repeating total reflection inside the glass substrate 63.

According to the above-described daylighting device 161, the light of the glare component can be attenuated by the low emissivity glass 62. Therefore, it is possible obtain the same effect as that of the previous configuration and to provide the comfortable indoor environment.

### Seventh Embodiment

Next, a daylighting device 170 according to a seventh embodiment will be described.

FIG. 25 is a perspective view for illustrating a schematic configuration and an arrangement state of a daylighting device according to the seventh embodiment. FIG. 26 is an enlarged diagram for illustrating a main part of the daylighting device according to the seventh embodiment.

As illustrated in FIG. 25, the daylighting device 170 is configured by including a daylighting panel 70, and a pair of mounting portions 71 and 71.

As illustrated in FIG. 26, the daylighting panel 70 includes a daylighting sheet 72, and a frame (supporting member) 73 that supports the daylighting sheet 72. The daylighting sheet 72 is configured by including the daylighting member 1, a transparent base material 74 which is disposed on the light incident surface 1a side of the daylighting member 1, and a plurality of light absorption layers 75 which are disposed on the light emitting surface 1b side of the daylighting member 1. The transparent base material 74, the daylighting member 1, and the light absorption layers 75 are integrally formed by an adhesive (not illustrated) or the like. It is also possible to use a plurality of light shielding layers instead of the plurality of light absorption layers 75. The light absorption layers 75 and the light shielding layer are formed using the same material as the material in the above-described embodiments.

The daylighting sheet 72 is supported in a state where the peripheral portion thereof is inserted into the aluminum frame 73. In this case, by disposing the daylighting sheet 72 in the frame 73 through the adhesive layer or a buffering material which are not illustrated, the daylighting sheet 72 can be fixed to the frame 73 and it is possible to prevent damage to the daylighting unit, an angle changing portion, and the like positioned in the peripheral portion. The adhesive layer, the buffering material, and the like are not necessarily required.

By supporting around the daylighting sheet 72 by the frame 73, the flatness of the daylighting sheet 72 is maintained, good daylighting performance is obtained.

In the daylighting panel 70, the transparent base material 74 side is disposed in a posture facing the window glass 1003 illustrated in FIG. 25. In the present embodiment, the daylighting panel 70 is fixed to a window frame 79 in the above-described installation direction through the pair of mounting portions 71 and 71 which is attached to the upper portion of the frame 73.

According to the daylighting device 170 of the present embodiment, the daylighting panel 70 is detachably attached to the window frame 79 by the mounting portions 71 and 71. Therefore, it is possible to easily attach or detach the daylighting device 170 to the window glass 1003 as compared with the aspect that the daylighting device 170 is directly attached to the window glass 1003. Accordingly, it is possible to efficiently perform the maintenance work and replacing work of the daylighting panel 70. In addition, it is possible to increase the size of the daylighting device 170, and it is possible to rapidly deal with the user's demand to install on the large window.

In the present embodiment, as the daylighting sheet 72, the daylighting film 15 of the above-described first embodiment or the daylighting film 17 according to the second embodiment can be used.

### Modification Example of Daylighting Panel in Seventh Embodiment

A daylighting panel 171 illustrated in FIG. 27 may have a configuration that the transparent base material 74, the daylighting member 1, and a light absorption film 78 which is detachably attached to the daylighting member 1 are supported by the frame 73. The light absorption film 78 is formed in a size for covering the entire light emitting surface 1b of the daylighting member 1.

A light shielding film may be used instead of the light absorption film 78. Here, as the light absorption film and the light shielding film, the light absorption film 32 and the light shielding film 34 according to the third embodiment can be adopted.

As a daylighting panel 172 illustrated in FIG. 28, a configuration that the daylighting member 1 and an anisotropic light diffusion film 19 are held by the frame 73 may be provided.

As a daylighting panel 173 illustrated in FIG. 29, a configuration that the daylighting member 1 and the transparent base material 74 are held by the frame 73 may be provided.

As a daylighting panel 174 illustrated in FIG. 30, a configuration that the daylighting member 1, the transparent base material 74, and the light absorption film 78 are held by the frame 73 may be provided. The transparent base material 74 is disposed on the light emitting surface 1b side of the daylighting member 1. The light absorption film 78 is disposed on the light emitting surface 1b side of the daylighting member 1 through the transparent base material 74. A configuration that the light absorption film 78 is detachably attached to the transparent base material 74 may be provided. In addition, a light shielding film may be used instead of the light absorption film 78.

In addition to the above-described configuration, an ultraviolet cutting film, an infrared cutting film, a light scattering film, and the like may be appropriately combined and stored in the frame 73.

According to the daylighting device 170 of the present embodiment including at least one of the above-described daylighting panels 70, 171, 172, 173, and 174, since the daylighting device 170 has a panel shape, it can be easily removed, and it is possible to arbitrarily switch the presence or absence of the daylighting performance. For example, the daylighting device 170 is disposed to the prescribed window according to the seasons or the like, and as illustrated in FIG. 31, it is possible to easily replace the daylighting device 170 to the other windows. In addition, since it is possible to replace the optical film inside the panel, it can be reconfigured into a film configuration that provides optimum lighting effect, even when the window to be installed is changed.

### Eight Embodiment

A daylighting device of an eight embodiment, for example, a blind 108 illustrated in FIG. 32 will be described.

FIG. 32 is a perspective view for illustrating an appearance of a blind in the eight embodiment. In addition, in the following description, the daylighting device is based on the positional relationship (upper and lower, left and right, and back and forth) of the blind (daylighting device) 108. Unless otherwise specified, the positional relationship of the blind 108 also coincides with the positional relationship facing the plane.

As illustrated in FIG. 32, the blind 108 includes a plurality of slats (light shielding member) 112 which are arranged in parallel in a horizontal direction with an interval therebetween, a supporting mechanism 113 that supports the plurality of slats 112 in a vertically suspendable manner. In addition, in the blind 108, the plurality of slats 112 are supported so as to be able to move up and down, and the plurality of slats 112 are tiltably supported.

The plurality of slats 112 includes a daylighting unit 115 which is configured by the plurality of daylighting slats 114 having daylighting properties and a light shielding unit 117 which disposed below the daylighting unit 115 is configured by the plurality of light shielding slats 116 having light shielding properties. In the following description, when the daylighting slats 114 and the light shielding slats 116 are not distinguished from each other, the slats 114 and the light shielding slats 116 are collectively handled as the slat 112.

As illustrated in FIG. 33, the daylighting slats 114 which configures the daylighting unit 115 is configured of a long plate-shaped transparent base material 118 having light transparency, a daylighting film 119 which is disposed at one surface side of the transparent base material 118, and a light absorption film 132 which is disposed on the other side of the transparent base material 118.

Here, as the daylighting film 119 and the light absorption film 132, the daylighting member and the light absorption film in the above-described embodiments can be used.

On the other hand, the light shielding slats 116 configuring the light shielding unit 117 is formed of a long plate-shaped substrate having light shielding properties. The substrate may be any generally used slats for so-called blinds, for example, a metal substrate or a wood substrate, a resin substrate can be exemplified. In addition, a substrate which is obtained by applying a coating or the like to the surface of the substrate can be exemplified.

The supporting mechanism 113 includes a plurality of ladder cords 138 which are arranged in parallel in the vertical direction (the transverse direction of the plurality of slats 112), a fixing box 137 that supports an upper end portion of the plurality of ladder cords 138, and an elevating bar 133 to be attached to the lower end portion of the plurality of ladder cords 138.

The supporting mechanism 113 includes an elevation operation unit 127 for elevating and lowering the plurality of slats 112, and a tilt operation unit 136 for tiling operation of the plurality of slats 112.

In the elevation operation unit 127, the elevating cord 129 is drawn into the fixing box 137 by pulling an operation cord 128 from a state where the elevating bar 133 is positioned at the lowest position. Accordingly, the plurality of slats 112 and the elevating bar 133 are moves upward while overlapping over the elevating bar 133 in order from the lower side. The elevating cord 129 is fixed by a stopper (not illustrated). Accordingly, the elevating bar 133 can be fixed to an arbitrary height position. Conversely, by releasing the fixing of the elevating cord 129 by the stopper, the elevating bar 133 can be lowered by the weight thereof. Accordingly, the elevating bar 133 can be positioned again at the lowest position.

As illustrated in FIG. 32, the tilt operation unit 136 has an operation lever 134 at one side of the fixing box 137. The operation lever 134 is attached so as to be rotatable about an axis. In the tilt operation unit 136, by rotating the operation lever 134 about the axis, vertical cords (not illustrated) configuring the ladder cords 138 can be vertically moved in opposite directions to each other. Accordingly, it is possible to tilt the plurality of slats 112 synchronously with each other a state where the gaps between the slats 112 are open and a state where the gaps between the slats 112 are closed.

The blind 108 having the above-described configuration is disposed in a state of being suspended from the upper portion of the window glass or the like and in a state where a plurality of slats 112 face the inner surface of the window glass. In addition, the daylighting unit 115 is disposed in a state where the surface on which the daylighting film 119 of each of the daylighting slats 114 is formed faces the window glass.

As illustrated in FIG. 33, in the daylighting unit 115, the light L incident to the inside from obliquely above to one surface of each of the daylighting slats 114 is emitted toward obliquely upward from the other side of each daylighting slats 114 to the outside. Specifically, in each of the daylighting slats 114, after the incident light is totally reflected at each daylighting unit of the daylighting film 119 and the travelling direction is changed, the incident light is emitted as the light directed to the upward, and is incident to the light absorption film 132 through the transparent base material 118. After the light including the glare component is attenuated in the light absorption film 132, the light contributing to the daylighting is emitted as the light directed to the indoor ceiling.

In this manner, the light of the glare component among the light L incident to the indoors through the window glass is attenuated, and the light L directed to the ceiling can be radiated to the back of the indoors without causing the person in the indoors to feel dazzle.

On the other hand, in the light shielding unit 117, the light L incident to the inside from obliquely above to one surface of each of the light shielding slats 116 is shielded by each light shielding slat 116. Since the light shielding unit 117 is positioned lower than the daylighting unit 115, among the light L incident to the indoors through the window glass 1003, it is possible to shield the light directed to the glare region or the light directed to the floor, mainly.

In addition, in the blind 108, by tilting the plurality of slats 112, it is possible to adjust angle of the light L directed to the ceiling in the daylighting unit 115. On the other hand, in the light shielding unit 117, by tilting the plurality of slats 112, the light L incident from each gap between the light shielding slats 116 is adjusted, or it is possible to see the outdoor through the window glass 1003 from each gap between light shielding slats 116.

By elevating and lowering the plurality of slats 112, for example, as illustrated in FIG. 34A, by lifting the elevating bar 133 to a prescribed position, the blind 108 can set the region facing the light shielding unit 117 of the window glass 1003 (FIG. 32) to be open.

Furthermore, as illustrated in FIG. 34B, in a case where the elevating bar 133 is positioned at the uppermost position, the entire surface of the window glass 1003 can be open (FIG. 34B). In this manner, by opening and closing the blind 108, it is possible to switch the presence or absence of daylighting performance as necessary.

As described above, in a case of using the blind 108 of the present embodiment, the light L incident to the indoors through the window glass 1003 is radiated toward the indoor ceiling by the plurality of daylighting slats 114 that configure the daylighting unit 115, and the light L directed to the glare region can be shielded by the plurality of daylighting slats 114 that configure the light shielding unit 117. In addition, in the present embodiment, since the intensity of the light of the glare component is attenuated by the light absorption layers 75 of the daylighting slats 114, it is possible to provide a good environment in which the person in the indoors does not feel dazzle.

FIGS. 35A to 35C are diagrams illustrating a configuration example of a daylighting slat.

As a daylighting slat 143 illustrated in FIG. 35A, a configuration including the daylighting member 1, the transparent base material 118 which is provided at the light incident surface 1a of the daylighting member 1, and the plurality of light shielding layers 7 which are provided at the light emitting surface 1b side of the daylighting member 1 may be provided. Here, the transparent base material 118 side faces the window glass, but it is not limited thereto.

As a daylighting slat 144 illustrated in FIG. 35B, a configuration including the daylighting member 1, the plurality of light shielding layers 7 which are provided at the light emitting surface 1b side of the daylighting member 1, and the transparent base material 118 which is provided at the light emitting surface 1b side of the daylighting member 1 through the light shielding layer 7 may be provided. Here, the daylighting member 1 side faces the window glass, but it is not limited thereto.

As a daylighting slat 145 illustrated in FIG. 35C, a configuration in which the daylighting member 1 and a light intensity attenuation film 5 which is provided at the light emitting surface 1b side are held by an external frame 139 may be provided.

The light intensity attenuation film 5 may be a light absorption layer for covering entire the light emitting surface 1b of the daylighting member 1 and may be a film formed of the plurality of light absorption layer or the plurality of light shielding layers which are disposed on the light emitting surface 1b.

The external frame 139 is configured by including a frame portion 139a which is formed in a frame shape, a transparent portion 139b which is fitted to one opening side of the frame portion 139a. The frame portion 139a is preferably configured of the material without light transparency. For example, the frame portion 139a is formed using aluminum or the like. The transparent portion 139b is not necessarily required, and may be configured of only the frame portion 139a.

By providing the external frame 139, it is possible to protect the microstructure surface side of the daylighting member 1. In a case of the blind including the slat from which the daylighting member 1 is exposed, if the slats arranged vertically are brought into contact with each other when the blind is opened and closed, there is a possibility that the microstructure of the daylighting member 1 is particularly damaged. Therefore, by adopting the configuration in which the daylighting member 1 is held by the external frame 139, it is possible to prevent the external frame 139 of each slat from being contacted each other at first, and to prevent the daylighting members 1 from being directly contacted to each other, when the blind is opened and closed. Accordingly, it is possible to obtain a stable daylighting performance even in long-term use.

### Ninth Embodiment

As a daylighting device of a ninth embodiment, for example, a roll screen 109 illustrated in FIG. 36 will be described.

FIG. 36 is a perspective view for illustrating an appearance of a roll screen in the ninth embodiment. FIG. 37 is a cross-sectional view taken along the line E-E′ of the roll screen 109 illustrated in FIG. 37. In addition, in the following description, the same parts as that of the daylighting film are not described and the same reference numerals will be given in the drawings.

As illustrated in FIG. 36, the roll screen 109 includes a screen (light shielding member) 402 and a winding mechanism (supporting mechanism) 403 for supporting the screen 402 to freely wind up. The screen 402 includes the daylighting unit 115 which is configured by a daylighting screen 402A, and the light shielding unit 117 which is positioned lower the daylighting unit 115 and configured by a light shielding screen 402B having light shielding properties.

As illustrated in FIG. 37, the daylighting screen 402A is configured by including a film-shaped (sheet-shaped) transparent base material 412 having light transparency, a daylighting film 413 which is provided one surface of the transparent base material 412, and a light absorption film 414 which is provided the other surface of the transparent base material 412.

The thickness of the transparent base material 412 is a thickness suitable for the roll screen 109.

The light shielding screen 402B is formed of a film-shaped (sheet-shaped) light shielding substrate 415 having light shielding properties.

A winding mechanism 403 includes a winding core 404 which is attached along the upper end portion of the screen 402, a lower pipe 405 which is attached along the lower end portion of the screen 402, a tension cord 406 which is attached to the center of the lower end portion of the screen 402, and a storage case 407 which stores the screen 402 which is wound around the winding core 404.

The winding mechanism 403 is fixed at the position where the screen 402 is pulled as a pull cord type (FIG. 38A) and by pulling the tension cord 406 further from the pulled out position, fixing can be released and the screen 402 can be automatically wound on the winding core 404 (FIG. 38B)

Regarding the winding mechanism 403, it is not limited to such a pull cord type, a chain type winding mechanism for rotating the winding core 404 with a chain, and an automatic winding mechanism for rotating the winding core 404 by a motor may be used.

The roll screen 109 having such a configuration is used in a state where the roll screen 109 faces the inner surface of the window glass 1003 while pulling out the screen 402 stored in the storage case 407 by the tension cord 406, in a state where the storage case 407 is fixed above the window glass 1003. In this time, the screen 402 is arranged in a state where the screen 402 faces the daylighting film 413 to the window glass 1003.

In the daylighting unit 115, the light L incident from one side of the screen 402 is emitted obliquely above is emitted toward the indoor ceiling while changing the travelling direction of the light by the daylighting screen 402A. Specifically, in the daylighting screen 402A, the light incident from the daylighting film 413 is incident to the daylighting screen 402A through the transparent base material 412, is totally reflected at each daylighting unit of the light absorption film 414, and then, is emitted as the light directed to the indoor ceiling.

On the other hand, the light shielding unit 117 shields the light L incident inside from obliquely above to one surface of each of the light shielding screen 402B. Since the light shielding unit 117 is positioned lower than the daylighting unit 115, among the light L incident in the indoors passing through the window glass 1003, it is possible to shield the light directed to the glare region or the light directed to the floor, mainly.

As described above, the roll screen 109 performs winding or pulling out of the screen 402 by the winding mechanism 403. Therefore, it is possible to switch the presence or absence of the daylighting performance as needed.

FIGS. 39A to 39C are diagrams illustrating a configuration example of a daylighting screen.

As a daylighting screens 401A and 408A illustrated in FIGS. 39A and 39B, a configuration in which the daylighting film 413 and the light absorption film 414 are laminated on the one surface side of the transparent base material 412 may be provided. The order of the lamination of the transparent base material 412, the daylighting film 413, and the light absorption film 414 can be appropriately changed. The light absorption film 414 has a plurality of light absorption layer or a plurality of light shielding layer. However, the light absorption layer for covering one surface of the daylighting film 413 may be used. As a daylighting screen 401A illustrated in FIG. 39A, the transparent base material 412 side may face the window glass, or as a daylighting screen 409A illustrated in FIG. 39B, the daylighting film 413 side may face the window glass.

As a daylighting screen 409A illustrated in FIG. 39C, a configuration in which the laminate of the daylighting film 413 and the light absorption film 414 is sandwiched between a pair of transparent base materials 412 may be provided.

As the daylighting screen 402A according to the embodiment of the present invention, although not illustrated, in addition to the configuration of the above-described daylighting screen 402A, for example, it is possible to include a functional film (functional member) such as a light diffusing film (light diffusing member) for diffusing the light in a direction toward the glare region, and a heat insulating film (heat insulating member) having light transparency for shielding radiant heat of the natural light (sunlight).

### Tenth Embodiment

As a daylighting device of a tenth embodiment, for example, a multi-layered glass having a multi-layered glass structure (so-called pair glass substrate) will be described.

FIG. 40 is a perspective view for illustrating a schematic configuration of a multi-layered glass (daylighting device) in a tenth embodiment. FIG. 41 is a cross-sectional view for illustrating a schematic configuration of the multi-layered glass in the tenth embodiment.

As illustrated in FIGS. 40 and 41, a multi-layered glass (daylighting device) 500 in the present embodiment includes a multi-layered glass structure 515, and a frame (not illustrated) for supporting the multi-layered glass structure 515. The multi-layered glass structure 515 is mainly configured by a first glass substrate 501 and a second glass substrate 502 which are disposed to face to each other, and a daylighting film 503 and a light absorption film 504 which are laminated at the first surface side of the second glass substrate 502 that is between the first glass substrate 501 and the second glass substrate 502. The daylighting film 503 and the light absorption film 504 are attached to a surface 502a of the second glass substrate 502 through a transparent adhesive layer 505 having the light transparency which is provided at the vicinity of the light absorption film 504.

The first glass substrate 501 and the second glass substrate 502 are separately disposed so as not to contact the daylighting film 503. For example, a buffering material (not illustrated) is disposed between the first glass substrate 501 and the daylighting film 503. The multi-layered glass structure 515 which is configured such that manner is incorporated into the frame (not illustrated), whereas a multi-layered glass 500 is configured.

The configuration of the multi-layered glass structure 515 is not limited to the above-described configuration. For example, as an optical film, it is also possible to appropriately change or add to an ultraviolet cut film, an anisotropic light scattering film, or the like.

### Modification Example of Multi-Layered Glass Structure

FIGS. 42A to 42C and FIG. 43 are diagrams illustrating a modification example of a multi-layered window structure.

As a multi-layered glass structure 516 illustrated in FIG. 42A, for example, a configuration in which the daylighting film 503 and the light absorption film 504 are laminated on a surface 501a of the first glass substrate 501 may be provided.

As a multi-layered glass structure 517 illustrated in FIG. 42B, for example, a configuration in which the daylighting film 503 and a light shielding film 506 are laminated on a surface 502a of the second glass substrate 502 may be provided.

As a multi-layered glass structure 518 illustrated in FIG. 42C, for example, a configuration in which the daylighting film 503 is provided on a surface 502a of the second glass substrate 502 and the light absorption film 504 (light shielding film 506) is provided on a surface 502b may be provided.

In addition, the multi-layered glass structure is not limited only the pair glass structure. For example, three or more glass substrates may be included.

A multi-layered glass structure 519 illustrated in FIG. 42D includes three glass substrates 501, 502, and 507. The second glass substrate 502 includes the daylighting film 503 and the light absorption film 504 on the surface 502b facing a third glass substrate 507.

The first glass substrate 501 is disposed at the surface 502a side of the second glass substrate 502, and disposed so as to pinch the third glass substrate 507 and the second glass substrate 502.

In addition, an optical film may be provided at a part of the region of the multi-layered glass.

For example, as the multi-layered glass structure 519 illustrated in FIG. 43, among 502a of the second glass substrates 502 facing the first glass substrate 501, the daylighting film 503 and the light absorption film 504 may be provided in the upper region R.

The above-described multi-layered glass structures 515 to 519 are attached to a window frame in a state where the structures are fitted into a frame 525 as illustrated in FIG. 44. The frame 525 is formed of aluminum, and supports the peripheral portions of the multi-layered glass structures 515 to 519.

As illustrated in FIG. 45A, the daylighting device according to the above-described first to seventh embodiments is not disposed outside the window glass 1003, and as illustrated in FIG. 45B, the daylighting device is disposed inside the window glass 1003. In addition, as the multi-layered glass 500 of the above-described tenth embodiment, by incorporating a plurality of optical films between the plurality of glass substrates, it is possible to protect against external factors that cause deformation and modification. Accordingly, the optical function of each component can be maintained for a long term without degradation of the daylighting device, and an optical film such as the daylighting film, or the light absorption film.

In addition, as a multi-layered glass, by integrating with the window glass so as not to expose the optical film to the inside the indoors also reduces the difference in appearance due to the presence or absence of the installation of the optical film.

Although the preferred embodiments of the present invention have been described above making reference to the attached drawings, it is obvious that the present invention is not limited to the examples. It would be obvious for those skilled in the art to think of various change examples or modification examples within the scope of the technical idea described in the claims, and these examples are naturally construed as being included in the technical range of the present invention. The configurations of each embodiment may be combined appropriately.

### Lighting Control System

FIG. 46 is a diagram for illustrating a room model including the daylighting device and a lighting control system and is a cross-section diagram taken along the line A-A′ of FIG. 47. FIG. 47 is a plan view for illustrating a ceiling of the room model 2000.

In the present invention, a ceiling material configuring a ceiling 2003a of a room 2003 in which external light is guided may have high light reflectivity. As illustrated in FIGS. 46 and 47, in the ceiling 2003a of the room 2003, a light reflective ceiling material 2003A is disposed as a ceiling material having light reflectivity. The light reflective ceiling material 2003A is intended to promote the introduction of outside light from a daylighting device 2010 disposed on a window 2002 toward the back of the indoors, and is disposed on the ceiling 2003a on the window side. Specifically, the light reflective ceiling material 2003A is disposed on a prescribed region E (a region of about 3 m from the window 2002) of the ceiling 2003a.

As described above, the light reflective ceiling material 2003A is efficiently guide the external light which is guided in the indoors through the window 2002 in which the daylighting device 2010 of the present invention (adopting any one of the daylighting devices in the above-described embodiments) is disposed to the back of the indoors.

As illustrated in FIG. 48, for example, the daylighting device 2010 includes a complex including the transparent base material 9, the daylighting member 1 which is provided on one surface side of the transparent base material 9, and the light absorption film 32, and has a configuration that the light absorption film 32 is detachably attached to the daylighting member 1. Such a complex is disposed on the upper portion side of the window 2002 in a state where the complex is supported by the frame 525.

The external light introduced from the daylighting device 2010 toward the indoor ceiling 2003a is reflected by the light reflective ceiling material 2003A, and is radiated to the desk top surface 2005a of a desk 2005 placed back of the indoors while changing the direction, thereby exerting the effect of brightening the desk top surface 2005a.

The light reflective ceiling material 2003A may have diffusely reflective or specularly reflective, in order to compatibilize the effect of brightening the desk top surface 2005a of the desk 2005 placed at the back of the indoors, and the effect the effect of suppressing uncomfortable glare for people in indoors, it is preferable that the characteristics of both are appropriately mixed.

Most of light introduced into the indoors by the daylighting device 2010 of the present invention is directed to the ceiling in the vicinity of the window 2002. However, in many cases, the light amount is sufficient in the vicinity of the window 2002. Therefore, by using the light reflective ceiling material 2003A as described above, light incident to the ceiling (region E) in the vicinity of the window can be distributed toward the back of the indoors with less light amount than the window side.

The light reflective ceiling material 2003A can be formed, for example, by embossing a metal plate such as aluminum with irregularities of about several tens of microns, depositing a metal thin film such as aluminum on the surface of the resin substrate having similar irregularities. Alternatively, irregularities formed by embossing may be formed with a curved surface with a larger period.

Furthermore, by appropriately changing the embossing shape formed on the light reflective ceiling material 2003A, it is possible to control distribution characteristics of light and distribution of light inside the indoors. For example, in a case where embossing is carried out in a strip shape extending towards the back of the indoors, the light reflected by the light reflective ceiling material 2003A expands in the horizontal direction (the direction intersecting the longitudinal direction of the irregularities) of the window 2002. In a case where the size and the direction of the window 2002 of the room 2003 are limited, by using such properties, the light is diffused in the horizontal direction by the light reflective ceiling material 2003A and can be reflected toward a direction of the back of the indoors.

The daylighting device 2010 of the present invention is used as a part of the lighting control system of the room 2003. For example, the lighting control system is configured of a configuration member of the entire room including the daylighting device 2010, a plurality of indoor lighting devices 2007, a solar radiation adjustment apparatus 2008 which is disposed on the window, a control system thereof, and the light reflective ceiling material 2003A which is disposed on the ceiling 2003a.

In the window 2002 of the room 2003, the daylighting device 2010 is disposed at the upper portion side, and the solar radiation adjustment apparatus 2008 is disposed at the lower portion side. Here, a blind is disposed as the solar radiation adjustment apparatus 2008. However, it is not limited thereto.

In the room 2003, a plurality of indoor lighting devices 2007 are disposed in a lattice pattern in the horizontal direction (Y direction) of the window 2002 and the depth direction (X direction) of the indoors. These plurality of indoor lighting devices 2007 configure entire the illumination system of the room 2003 together with the daylighting device 2010.

As illustrated in FIGS. 46 and 47, for example, the office ceiling 2003a in which a length L1 of the window 2002 in a horizontal direction (Y direction) is 18 m and a length L2 of the room 2003 in the depth direction (X direction) is 9 m is illustrated. Here, the indoor lighting device 2007 is disposed in a lattice shape with an interval P of 1.8 m of the ceiling 2003a in the horizontal direction (Y direction) and in the depth direction (X direction), respectively.

More specifically, 50 indoor lighting devices 2007 are arranged in 10 rows (Y direction)×5 columns (X direction).

The indoor lighting device 2007 includes an indoor lighting device 2007a, an illuminance detection unit 2007b, and a control unit 2007c, in which the illuminance detection unit 2007b and the control unit 2007c are integrally configured in the indoor lighting device 2007a.

The indoor lighting device 2007 may include a plurality of indoor lighting devices 2007a and a plurality of illuminance detection units 2007b, respectively. However, the illuminance detection unit 2007b is provided one for each of the indoor lighting devices 2007a. The illuminance detection unit 2007b receives the reflected light of the radiated surface illuminated by the indoor lighting device 2007a and detects the illuminance of the radiated surface. Here, an illuminance detection unit 200b detects the illuminance of the desk top surface 2005a of the desk 2005 placed in the indoors.

The control units 2007c provided one by one in each indoor lighting device 2007 are connected to each other. Each of the indoor lighting devices 2007 performs feedback control for adjusting light output of a LED lamp of each of the indoor lighting devices 2007a by the control units 2007c which are connected to each other such that the illuminance of the desk top surface 2005a to be detected by each of the illuminance detection unit 2007b becomes a certain target illuminance LO (for example, average illuminance: 750 1×).

FIG. 49 is a graph for illustrating a relationship between illuminance of light (natural light) guided into indoors by the daylighting device and illuminance of light (lighting control system) by an indoor lighting device. In FIG. 49, the vertical axis indicates illuminance (lx) of the desk top surface, and the horizontal axis indicates a distance (m) from the window. In addition, the broken line in the drawing indicates the indoor target illuminance.

(A: illuminance by daylighting device, B: illuminance by indoor lighting device, C: total illuminance)

As illustrated in FIG. 49, the illuminance on the desk top surface due to the light guided by the daylighting device 2010 is as bright as in the vicinity of the window, and the effect decreases as the farther from the window. In the room to which the daylighting device 2010 of the present invention is adopted, illuminance distribution in the backward direction of the room is generated by natural daylighting from the window in the daytime.

Therefore, the daylighting device 2010 of the present invention is used in combination with the indoor lighting device 2007 that compensates for the indoor illuminance distribution. The indoor lighting device 2007 disposed on the indoor ceiling detects the average illuminance under each of the devices by the illuminance detection unit 2007b and turns on the light by dimming and controlling such that the desk top surface illuminance of the entire room becomes a constant target illuminance LO. Accordingly, the light turns on while increasing the output according to directing the back of the room with a S3 row, a S4 row, and a S5 row without hardly turning on a Si row and a S2 row which are disposed in the vicinity of the window.

As a result, the desk top surface of the room is illuminated by the sum of the illuminance by natural daylighting and the lighting by the indoor lighting device 2007, and it is possible to realize 750 1× (the recommended maintenance illuminance in the office of “JIS Z9110 Lighting General Rules”) that is the desk top surface illuminance which is sufficient for the office work over the entire room.

FIG. 50 is a graph for illustrating the solar irradiance of Tokyo in a spring equinox day. In FIG. 50, the vertical axis indicates the solar irradiance Mj/m² and the horizontal axis indicates the time. FIG. 50 is an example of data stored in “Solar Irradiance Amount Database” of the New Energy and Industrial Technology Development Organization (NEDO). As illustrated in FIG. 50, for example, the solar irradiance of Tokyo in the spring equinox day is greatly varied with the lapse of time, and distribution peaks exist at 10 o'clock, 13 o'clock, and 16 o'clock, respectively.

In each distribution peak, the solar irradiance changes almost symmetrically in time of before and after. The solar irradiance increases with sunrise, and the solar irradiance at 10 o'clock am is 150 Mj/m². Thereafter, the solar irradiance began to gradually decline, after the solar irradiance decreased to 55 Mj/m² at 12 o'clock pm, the solar irradiance is rapidly increased again, and it became the solar irradiance near 200 Mj/m² that is the highest in one day at 13 o'clock pm. The solar irradiance is decreased again, and the solar irradiance is slightly increased at 16 o'clock.

The daylighting device 2010 of the present invention synchronizes the daylighting from the daylighting device 2010 which is varied with solar irradiance of a day, that is, the sun altitude of a day, and light due to the indoor lighting device 2007. Therefore, it is possible to obtain a constant illuminance regardless of the time or the position of the room or window. As a result, it is possible to achieve a comfortable indoor environment and efficient energy saving.

As described above, by using the daylighting device 2010 together with the lighting control system (indoor lighting device 2007), even in a case where an amount of the light incident to the daylighting device 2010 is varied due to season, time, weather, or the like, a comfortable indoor environment can be obtained by dimming the light based on the information from the illuminance detection unit 2007b while capturing the sunlight and supplementing the deficient illuminance with the indoor lighting device 2007a. As a result, it is possible to secure a desk top surface illuminance which is sufficient for the office work over the entire room. Accordingly, a more stable bright light environment can be obtained without being influenced by the season and the weather.

### INDUSTRIAL APPLICABILITY

One aspect of the present invention is to improve the daylighting property on the ceiling regardless of the incident angle of the incident light, and to sufficiently use natural light (sunlight) to ensure a bright environment in indoors, and can be applied to the daylighting device and the daylighting system which need to further suppress glare.

### REFERENCE SIGNS LIST

1, 901 DAYLIGHTING MEMBER
2 SUBSTRATE
2a FIRST SURFACE
2b SECOND SURFACE
3 DAYLIGHTING UNIT
6, 12, 41, 42, 75 LIGHT ABSORPTION LAYER
7 LIGHT SHIELDING LAYER (LIGHT ABSORPTION LAYER)
8, 13 ADHESIVE LAYER
L, L1, L2, L3, L5 LIGHT
P INTERVAL
10, 100, 120, 130, 131, 140, 141, 142, 150, 151, 152, 153, 160, 161, 170, 900, 2010 DAYLIGHTING DEVICE
32 LIGHT ABSORPTION FILM (LIGHT ABSORPTION LAYER)
34 LIGHT SHIELDING FILM (LIGHT ABSORPTION LAYER)
70, 171, 172, 173, 174 DAYLIGHTING PANEL
71 MOUNTING PORTION
73, 525 FRAME
108 BLIND (DAYLIGHTING DEVICE)
112 SLAT
200b, 2007b DETECTION UNIT
401A, 402A, 409A DAYLIGHTING SCREEN
402 SCREEN
403 WINDING MECHANISM
500 MULTI-LAYERED GLASS (DAYLIGHTING DEVICE)
501 GLASS SUBSTRATE
501 FIRST GLASS SUBSTRATE
502 SECOND GLASS SUBSTRATE
1003 WINDOW GLASS
1003 WINDOW GLASS (INSTALLATION TARGET)
1006 INDOORS
2002 WINDOW
2007 INDOOR LIGHTING DEVICE
2007c CONTROL UNIT

1. A daylighting device comprising:
a daylighting member including a first substrate having light transparency and a plurality of daylighting units having light transparency which are provided on a first surface of the first substrate,
wherein the daylighting unit has a reflective surface which reflects light incident to the daylighting unit, and the light which is reflected on the reflective surface and emitted from a second surface of the first substrate has characteristics that the light proceeds toward a space on the same side as the side where the light is incident to the reflective surface among two spaces divided with a virtual plane as a boundary which is vertical to the second surface of the first substrate and parallel to an extension direction of the daylighting unit, and
wherein the daylighting member exhibits light absorption characteristics for absorbing a part of the light incident to the plurality of daylighting units.

2. The daylighting device according to claim 1,
wherein at least one of the plurality of daylighting units and the first substrate exhibits the light absorption characteristics.

3. The daylighting device according to claim 2,
wherein at least one of the daylighting units and the first substrate is configured of a material having the light absorption characteristics.

4. The daylighting device according to claim 1,
wherein one or more light absorption layers are provided on the first substrate.

5. The daylighting device according to claim 4,
wherein the light absorption layer is provided over the entire region in the first surface of the first substrate.

6. The daylighting device according to claim 4, further comprising:
the plurality of light absorption layers,
wherein the plurality of light absorption layers are provided with an interval therebetween in an arrangement direction of the plurality of daylighting units.

7. The daylighting device according to claim 4, further comprising:
the plurality of light absorption layers,
wherein the plurality of light absorption layers are provided with an interval therebetween in a plate thickness direction of the first substrate.

8. The daylighting device according to claim 4,
wherein a light transmittance of the light absorption layer is less than 90%.

9. The daylighting device according to claim 4,
wherein the light absorption layer is detachably provided on the first substrate.

10. The daylighting device according to claim 1,
wherein the daylighting member is attached to an installation target through an adhesive layer which is provided on any one side of the plurality of daylighting units and the second surface of the first substrate.

11. The dayighting device according to claim 10,
wherein the adhesive layer has light absorption characteristics.

12. The daylighting device according to claim 1, further comprising:
a daylighting panel including the daylighting member and a frame that supports the daylighting member; and
a mounting portion for detachably mounting the daylighting panel to the installation target.

13. A daylighting apparatus comprising:
a plurality of slats which are disposed side by side with a prescribed interval therebetween; and
a tilting mechanism that supports the slats so as to be freely tilted,
wherein the daylighting device according to claim 1 is used for at least a part of the plurality of slats.

14. A daylighting apparatus comprising:
a daylighting screen; and
a winding mechanism that causes the daylighting screen to be freely wound,
wherein the daylighting device according to claim 1 is used as the daylighting screen.

15. A daylighting apparatus comprising:
at least,
a first glass substrate which has light transparency and to which external light is incident;
a second glass substrate which is disposed facing the first glass substrate and has light transparency; and
the daylighting device according to claim 1 which is disposed between the first glass substrate and the second glass substrate, or on the second glass substrate.

16. A daylighting system comprising:
a daylighting device;
an indoor lighting device;
a detection unit that detects indoor illuminance; and
a control unit that controls the indoor lighting device and the detection unit,
wherein the daylighting device according to claim 1 is adopted as the daylighting device.

17. The daylighting system according to claim 16,
wherein the daylighting device is provided on a low emissivity glass.
